(19) United States
(12) Patent Application Publication
(10) Pub. No.: US 2026/0368209 A1
(43) Pub. Date: Nov. 19, 2026

(54) GENERATION OF SITUATIONAL AWARENESS DATA THROUGH OBTAINING AND ANALYZING GEOSPATIAL DATA

(71) Applicant: Ursa Space Systems Inc., Ithaca, NY (US)

(72) Inventors: Adam John Maher, Ithaca, NY (US); Andrew T. Morse, Jr., Lansing, NY (US); Douglas Edwin Wood, Great Falls, VA (US)

(73) Assignee: Ursa Space Systems Inc., Ithaca, NY (US)

(21) Appl. No.: 19/679,361

(22) Filed: May 15, 2026

Related U.S. Application Data
(60) Provisional application No. 63/807,356, filed on May 16, 2025.

(51) Int. Cl. G06F 16/29; G06F 16/334; G06F 16/34

(52) U.S. Cl. CPC G06F 16/29; G06F 16/3344; G06F 16/345

(57) ABSTRACT

An apparatus may process a natural language query, using at least one model, to identify one or more sets of operations for data collection and analysis from a plurality of sets of operations for data collection and analysis, each of the plurality of sets of operations for data collection and analysis associated with a domain and each of the plurality of sets of operations for data collection and analysis comprising at least one data collection operation for overhead imagery data. An apparatus may identify, based on the one or more sets of operations for data collection and analysis, data to be collected for performing an analysis in response to the natural language query. An apparatus May orchestrate collection of the identified data.

### CROSS-REFERENCE TO RELATED APPLICATIONS

The present application claims priority under 35 U.S.C. § 119(e) to U.S. Provisional Patent Application Ser. No. 63/807,356, filed May 16, 2025, and titled “Generation of Situational Awareness Data Through Obtaining and Analyzing Geospatial Data,” the contents of which are incorporated herein in their entirety.

### BACKGROUND

Geospatial data, including imagery and other location-referenced information, is collected and used across a variety of governmental, commercial, scientific, and consumer contexts. Organizations use a range of systems and services to acquire, store, manage, visualize, and analyze such data. These systems may support tasks such as mapping, monitoring, reporting, and responding to information requests.

### SUMMARY

Described herein are various examples of techniques for data acquisition and analysis, which may in some cases be used in obtaining and analyzing geospatial data to yield situational awareness data. Such geospatial data and/or situational awareness data may in various embodiments include information across a broad range of industries and expertise levels.

In some aspects, the techniques described herein relate to a computer-implemented method including: processing a natural language query, using at least one model, to identify one or more sets of operations for data collection and analysis from a plurality of sets of operations for data collection and analysis, each of the plurality of sets of operations for data collection and analysis associated with a domain and each of the plurality of sets of operations for data collection and analysis including at least one data collection operation for overhead imagery data; identifying, based on the one or more sets of operations for data collection and analysis, data to be collected for performing an analysis in response to the natural language query; and orchestrating collection of the identified data.

In some aspects, the techniques described herein relate to a computer-implemented method, wherein processing the natural language query using the at least one model to identify the one or more sets of operations includes matching one or more semantic tags determined from the natural language query to one or more semantic tags associated with the one or more sets of operations for data collection and analysis.

In some aspects, the techniques described herein relate to a computer-implemented method, wherein identifying the one or more sets of operations for data collection and analysis from the plurality of sets of operations for data collection and analysis further includes analyzing geocoding data.

In some aspects, the techniques described herein relate to a computer-implemented method, wherein the one or more sets of operations for data collection and analysis, from among the plurality of sets of operations, include a second plurality of set of operations for data collection and analysis each selected for different aspects of the natural language query.

In some aspects, the techniques described herein relate to a computer-implemented method, further including: executing data collection steps and data analysis steps, of the one or more sets of operations for data collection and analysis, in an order defined by the one or more sets of operations for data collection and analysis.

In some aspects, the techniques described herein relate to a computer-implemented method, wherein processing the natural language query to identify the one or more sets of operations includes: in response to determining, based on the processing, that a match has not been made based on the processing of the natural language query using the at least one model, presenting one or more candidate sets of operations for data collection and analysis to a user.

In some aspects, the techniques described herein relate to a computer-implemented method, wherein processing the natural language query using the at least one model to identify the one or more sets of operations for data collection and analysis, from among the plurality of sets of operations for data collection and analysis, includes identifying a facility type associated with a location, the location being associated with the natural language query.

In some aspects, the techniques described herein relate to a computer-implemented method, further including: generating a new set of operations for data collection and analysis based on the natural language query; presenting the new set of operations for data collection and analysis to a reviewer for approval; receiving approval of the new set of operations for data collection and analysis from the reviewer; and adding the new set of operations for data collection and analysis to the plurality of sets of operations for data collection and analysis.

In some aspects, the techniques described herein relate to a computer-implemented method, further including: analyzing the collected data, the collected data including overhead imagery data; generating, using at least one second model, a report based on the collected data and analysis of the collected data, the report generated using the at least one second model including natural language text; and outputting the report.

In some aspects, the techniques described herein relate to a computer-implemented method, wherein generating the report including the at least one second model includes: determining, based on a draft of the report, that supplemental data is to be collected for at least a portion of the analysis; determining, based on the one or more sets of operations for data collection and analysis, supplemental data available for collection; obtaining the supplemental data; compiling the collected data and the supplemental data; generating, using the at least one second model, a second draft of the report based on the compiled data and analysis of the compiled data.

In some aspects, the techniques described herein relate to a computer-implemented method, wherein orchestrating collection of the identified data includes: identifying data to be collected for an analysis; identifying candidate data sources for the data to be collected, available within one or more data sources; selecting analysis data from the candidate data sources based on availability, cost, and compatibility with the analysis; and obtaining the selected data from at least one of the one or more data sources.

In some aspects, the techniques described herein relate to a computer-implemented method, further including analyzing the selected data; generating, using at least one second model, a natural language report based on the selected data and analysis of the selected data; and outputting the natural language report.

In some aspects, the techniques described herein relate to a computer-implemented method, further including: determining, based on one or more sets of operations for data collection and analysis, that there is an information gap between collected data and data to respond within a sufficiency threshold to the natural language query; determining, based on the one or more sets of operations for data collection and analysis, supplemental data available to address the information gap; obtaining the supplemental data; compiling the collected data and the supplemental data; analyzing the compiled data; generating, using at least one second model, a report based on the compiled data and analysis of the compiled data, the report including natural language; and outputting the report.

In some aspects, the techniques described herein relate to an apparatus including: at least one processor; and at least one computer-readable storage medium having encoded thereon executable instructions that, when executed by the at least one processor, cause the at least one processor to carry out a method including: identifying data to be collected for an analysis; identifying candidate data sources for the data to be collected, available within one or more data sources; selecting analysis data from the candidate data sources based on availability, cost, and compatibility with the analysis; and obtaining the selected data from at least one of the one or more data sources. In some aspects, the techniques described herein relate to an apparatus, wherein the method further includes: determining the one or more data sources based on one or more sets of operations for data collection and analysis that define data collection steps and data analysis steps.

In some aspects, the techniques described herein relate to an apparatus, wherein selecting the analysis data includes selecting based on a time of interest and a resolution of the candidate data.

In some aspects, the techniques described herein relate to an apparatus, wherein the method further includes: identifying data to be collected for analysis, based at least in part on: processing a natural language query using at least one model to identify one or more sets of operations for data collection and analysis from a plurality of sets of operations for data collection and analysis, each set of operations for data collection and analysis from the plurality of sets of operations for data collection and analysis associated with a domain; and identifying, based on the one or more sets of operations for data collection and analysis, data including overhead imagery data to be collected for performing an analysis in response to the natural language query.

In some aspects, the techniques described herein relate to an apparatus, wherein the one or more data sources include data sources accessed through multiple application programming interfaces.

In some aspects, the techniques described herein relate to an apparatus, wherein selecting analysis data from the candidate data includes selecting free data before archived data and selecting archived data before generated data.

In some aspects, the techniques described herein relate to at least one computer-readable storage medium having encoded thereon executable instructions that, when executed by at least one processor, cause the at least one processor to carry out a method, the method including: determining, based on one or more sets of operations for data collection and analysis, that there is an information gap between collected data and data to respond within a sufficiency threshold to a user natural language query; determining, based on the one or more sets of operations for data collection and analysis, supplemental data available to address the information gap; obtaining the supplemental data; and compiling the collected data and the supplemental data.

In some aspects, the techniques described herein relate to an at least one computer-readable storage medium, wherein the method further includes: presenting an initial report from the collected data to a user; presenting information regarding the information gap and suggested supplemental data to the user; determining, based on input from the user, what supplemental data to obtain to address the information gap.

In some aspects, the techniques described herein relate to an at least one computer-readable storage medium, wherein obtaining the supplemental data includes: interfacing with a plurality of data sources to identify candidate data satisfying data requirements to address the information gap; selecting selected data from the candidate data based on availability, cost, and compatibility with the analysis; and obtaining the selected data from at least one of the plurality of data sources.

In some aspects, the techniques described herein relate to an at least one computer-readable storage medium, wherein obtaining the collected data includes: processing a natural language query using at least one model to identify one or more sets of operations for data collection and analysis from a plurality of sets of operations for data collection and analysis, each set associated with a domain; identifying, based on the one or more sets of operations for data collection and analysis, data including overhead imagery data to be collected for performing an analysis in response to the natural language query; identifying candidate data sources for the data to be collected available within one or more data sources; selecting analysis data from the candidate data based on availability, cost, and compatibility with the analysis; and obtaining the selected data from at least one of the one or more data sources.

In some aspects, the techniques described herein relate to an at least one computer-readable storage medium, wherein the method further includes deduplicating portions of the collected data and the supplemental data.

In some aspects, the techniques described herein relate to an at least one computer-readable storage medium, wherein the method further includes determining whether further supplemental data is needed after the supplemental data is obtained.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of a system for generating situational awareness through obtaining and analyzing geospatial data, in accordance with some embodiments of the technology described herein;

FIG. 2 is a flowchart of an illustrative method for generating situational awareness through obtaining and analyzing geospatial data, in accordance with some embodiments of the technology described herein;

FIG. 3 is a flowchart of an illustrative method for generating situational awareness through obtaining and analyzing geospatial data, in accordance with some embodiments of the technology described herein;

FIG. 4 is a flowchart of an illustrative method for generating situational awareness through obtaining and analyzing geospatial data, in accordance with some embodiments of the technology described herein;

FIG. 5 is a flowchart of an illustrative method for generating situational awareness through obtaining and analyzing geospatial data, in accordance with some embodiments of the technology described herein;

FIG. 6 is a flowchart of an illustrative method for generating situational awareness through obtaining and analyzing geospatial data, in accordance with some embodiments of the technology described herein;

FIG. 7 is a flowchart of an illustrative method for generating situational awareness through obtaining and analyzing geospatial data, in accordance with some embodiments of the technology described herein;

FIG. 8 is a flowchart of an illustrative method for generating situational awareness through obtaining and analyzing geospatial data, in accordance with some embodiments of the technology described herein;

FIG. 9 is a schematic diagram of an illustrative computing device with which some aspects described herein may be implemented.

FIGS. 10-15 are examples of images of GUI interfaces which may be produced by some aspects described herein.

FIGS. 16-19 are examples of outputs which may be produced by some aspects described herein.

FIG. 20 is a flowchart of an illustrative method for generating situational awareness through obtaining and analyzing geospatial data, in accordance with some embodiments of the technology described herein;

### DETAILED DESCRIPTION

Described herein are various examples of techniques for data acquisition and analysis, which may in some cases be used in obtaining and analyzing geospatial data to yield situational awareness data. Such geospatial data and/or situational awareness data may in various embodiments include information across a broad range of industries and expertise levels.

In some embodiments described herein, a requester may use a natural language interface (e.g., a natural language text input) to specify a goal or ask a query that the requester thinks can be achieved or would like to achieve using geospatial data including geospatial imagery, overhead data, or other geospatial information. In some cases, the input from the requester may not with particularity identify a geospatial area to which the goal relates, a time to which the goal relates, the type(s) of geospatial data to be obtained from (at least) that area and (at least) that time so as to obtain sufficient information to address the goal, the source(s) from which to obtain that geospatial data, the manner(s) in which to analyze the geospatial data to address the goal, and/or the outputs to provide to address the goal. Instead, some embodiments described herein may identify that information based on a processing of the input from the requester. In some embodiments, a system may—including automatically, or without human involvement at the platform side (e.g., without human involvement other than the requester, who may be a remote user of the system and provide the input via one or more computer networks, including the Internet)—process the input from the requester to identify the manner in which to address the goal specified by the requester's input, including identifying one or more of the information listed above that the input may not identify with particularity. The system may also, based on such information, obtain geospatial data, analyze it, and generate outputs, which again may be performed in some embodiments automatically or without human involvement on the platform side. In some such embodiments, the system may use one or more vector databases and/or one or more trained models to perform the analysis, with such models including machine learning models including large language models (LLMs) or other autoregressive models. Some embodiments may therefore operate with artificial intelligence techniques to generate an output that addresses the requester's goal, despite that the input does not provide particular information on how the goal is to be accomplished.

Satellite imagery has been used in the past to generate intelligence information or other analytics. In conventional satellite analysis scenarios, an input is provided to a system that specifically identifies, such as with latitude/longitude/altitude or other coordinates, an area that a user wishes to be imaged and what type of image to obtain, and (in some cases) may additionally identify precisely how the user wants the image analyzed to obtain some information from the image. Such systems place a large responsibility on the user to know specifically what they want and how to get it. These systems have persisted for decades and are by far the prevailing approach to satellite image capture and analysis. Companies that interact with (as customers of) sources of satellite imagery and analysis place an emphasis on hiring employees with experience in knowing precisely what images to capture and how, and how to specify this so as to drive a satellite imagery and analysis system to provide precisely what is asked for. Despite decades of use of this business model by satellite imagery and analysis companies, and billions (if not trillions) spent on satellite imagery by highly sophisticated consumers of satellite information—including government or costly private intelligence services, or costly reporters of economic activity, or the like is a well-known fact that much of the energy and funds spent on conventional approaches to satellite imagery and analysis is at best misdirected or at worst wasted. This is because despite the customer companies hiring highly talented analysts who can identify with precision what imagery and what analysis is desired to be provided by the satellite imagery and analysis vendor, the analysts may often be mistaken as to the type of imagery to be obtained or type of analysis to be done. The analysts' work is treated as something of a guessing game or a numbers game, albeit informed by deep background and education. The analysts are trying to make the best requests and, if the request was not accurate or didn't provide the desired results, will simply make another request. This is built into the industry, and sometimes leads to multiple requests being made when initial requests (even if answered with precisely the requested information) do not yield desired results. This can increase costs and introduce delays in analysis.

Efforts have been made at applying artificial intelligence (AI) to such a conventional system, where highly skilled analysts working at sophisticated companies provide detailed requests to satellite imagery and analysis vendors. In such an application of AI, the operation of the satellite imagery and analysis vendor may be substantially the same, though automated with AI. A skilled analyst may provide a detailed, prescriptive request identifying what image is to be obtained and how it is to be analyzed, and an AI system may act responsive to those detailed instructions to provide what was requested. While the use of AI may allow for decreasing some employee costs at the vendor or maybe eke out some small time savings, such AI systems do not address a core difficulty with the conventional problems noted above. This core difficulty is that the analysts' best guesses as to what is to be imaged may be incorrect, or may not yield the desired information.

The inventors have recognized and appreciated that, rather than merely automating the conventional approach, artificial intelligence and models might be used in a completely different manner to obtain and analyze geospatial information. Such an approach may include, rather than having a requester specify with particularity all aspects of a desired imaging and analysis, describing with a natural language input a goal to be accomplished, such as in a statement describing the goal or a query that raises a question identifying or implying the goal. From there, in accordance with some techniques described herein, a system may identify how to accomplish that goal, including some or all of the information mentioned above: a geospatial area to which the goal relates, a time to which the goal relates, the type(s) of geospatial data to be obtained from (at least) that area and (at least) that time so as to obtain sufficient information to address the goal, the source(s) from which to obtain that geospatial data, the manner(s) in which to analyze the geospatial data to address the goal, and/or the outputs to provide to address the goal.

The inventors have recognized that there was a fundamental misdirection with how image and evidence collection and analysis is traditionally done. To use a crime analogy, if a crime was committed on a street corner, following the crime the police may during their investigation capture (or asked a vendor to capture) detailed imagery of the street corner, to try to capture information indicative of what may have transpired. They would then study those images as a part of their investigation into what transpired. A fundamental difficulty, of course, is that the images were all captured following the crime and do not show the events that led up to the crime or were occurring contemporaneous with the crime. Nonetheless, this manner of police investigation is common. The same is true of capture of satellite imagery for intelligence or economic analysis.

The inventors have recognized and appreciated that rather than specifying the location (the street corner) and what is to be done (image all angles of the street corner), there would be advantages to a system that may receive a specification of a goal: Capture information indicative of what led to the crime being committed and may explain what transpired. It may be that rather than capturing images of other areas, or capturing different images of the area, may be more informative.

Accordingly, described herein are techniques for analyzing a natural language input query provided by a user, describing a goal to be accomplished and/or a question to be answered using at least in part geospatial data, and processing that natural language input to a manner in which to achieve the goal and/or answer that question in full or in part. Such processing may include identifying from the natural language input the data to be collected and how to analyze that data, including other examples of information described above or in detail below. In some embodiments, once such information has been determined from the processing of the input, a system may operate to obtain the data, such as by communicating electronically with one or more sources of data to request the data or trigger collection/capture of the data, and may analyze the data to generate one or more results to present in response to the query.

In some embodiments described herein, a geospatial system operating in accordance with some embodiments described herein can deliver rapid, scalable, and/or automated intelligence solutions, which may in some cases reduce intelligence cycle times and improve situational awareness. Such a system may provide solutions across a variety of industries including defense, security, emergency response, and commercial sectors. In some embodiments, a system may include an interface allowing non-expert users to leverage the system by interpreting and analyzing the users' natural language queries to determine an appropriate data collection and analysis strategy. Additionally, in some embodiments, the system may enable sensor tasking automation, data fusion, and query interpretation to orchestrate end-to-end workflows from request input to finished reporting.

In some embodiments, a geospatial system can integrate data from multiple sources, such as overhead data and others (e.g., data from Synthetic Aperture Radar (SAR), Electro-Optical (EO), Radio Frequency (RF), Automatic Identification System (AIS), electronic-intelligence (ELINT), hyperspectral imaging spectrometers and other data collection system as well as open-source intelligence platforms). In some embodiments, the system can automate analytics (such as by using standard statistical methods, rules-based approaches, and/or AI-based analytics) to determine an appropriate data collection protocol, perform analysis on collected and integrated data, determine a confidence interval, and detect anomalies and behavioral patterns. A geospatial system may further enable the use of the system by requesters without experience in geospatial analysis by including an adaptive user interface and adapting reporting to the requester, such as by including high-level and/or intuitive summaries of the analysis for requesters who would benefit from the summaries.

In some embodiments, a geospatial system can reduce the latency between request and decision-making by increasing the rate of data collection (such as by using already collected data or providing access to additional data collection routes) and data analysis. Examples of applications include maritime domain awareness, border monitoring, disaster monitoring and response, economic monitoring, as well as many others.

In some embodiments, a geospatial system may be customizable and allow the incorporation of requester data and standard operating protocols into the system and methods. A geospatial system may allow the fusion of different data feeds allowing for multimodal insights and a holistic picture of ground conditions. A geospatial system may enhance analyst productivity by automating routine tasks, allowing analysts to focus on more complex work.

In some embodiments, a requester can log into the geospatial system and access a recommended case or enter a new use case. If a geospatial system recognizes the use case, the geospatial system may recommend time-relevant prompts to the requester. The geospatial system may translate the request to a series of steps, tasks, and/or actionable queries. A geospatial system may determine the appropriate tasking for its resources and may automate the data acquisition, processing, and analytics. A geospatial system may identify data intelligence gaps (such as for data resolution or query response) and may task further data or image collection to resolve. A geospatial system may aggregate and fuse different geospatial datasets, analyze and resolve any discrepancies, and create clean, analysis-ready composite data. In some embodiments, this process may be fully or partially automated, reducing time and human error and allowing more time for analysis, interpretation, and decision-making.

In some embodiments, the geospatial system may extract insights from the composite data, such as determining geospatial patterns, performing temporal analysis, and flagging anomalies, unusual behaviors, and places of interest (such as infrastructures and hotspots.) In some embodiments, the geospatial system may present the answer to the requester's query which may be interactive and/or tailored to the requester. For instance, the geospatial system may present objects, areas, and events of interest identified along with explaining insights, observations, and objectives. In some embodiments, the geospatial system may present a summary of the data acquired, the processing done, and the analyses deployed to arrive at the results. In some embodiments, a geospatial system may produce a report summarizing findings, methodologies, identified gaps, and recommendations and may present options for further data collection and analysis.

Described below are various examples of ways in which techniques described herein may be implemented. It should be appreciated, however, that the examples described below are merely illustrative of ways in which some of the techniques described herein may be implemented. Other embodiments are possible.

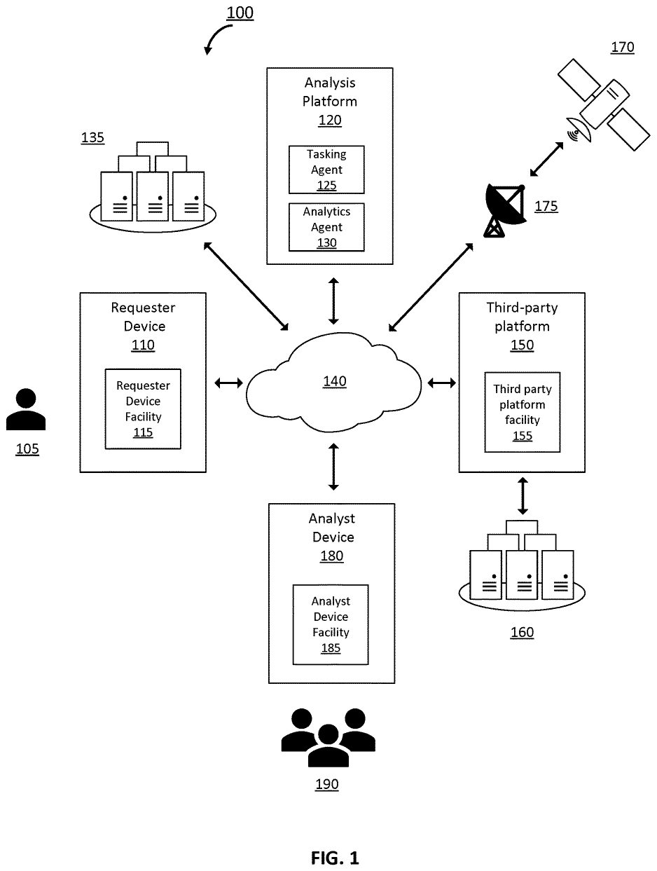

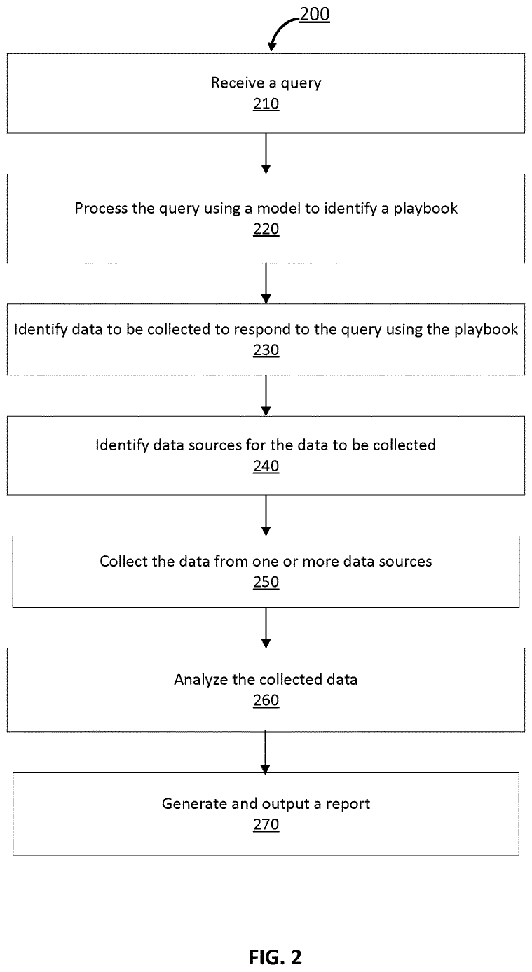

FIG. 1 illustrates an example of a geospatial system 100 (the “system”). In some embodiments, the geospatial system 100 may include a requester device 110, an analyst device 180, one or more third-party platforms 150, one or more third-party databases 160, a network 140, one or more overhead data collection devices 170, one or more communication devices 175, one or more analysis platforms 120, and one or more databases 135. This list is not exhaustive, and not every embodiment of the geospatial system 100 will necessarily include every part. In some alternative systems, the parts may be combined or split into smaller units. Detailed descriptions of some embodiments of components of the system 100 and interactions therebetween are described below. Some examples of methods performed by system 100 are described below with reference to FIGS. 2-4. Specific examples of applications of system 100 are set forth in the Examples 1-8 below.

A requester 105 may interface with a requester device 110 using the requester device facility 115. In some embodiments, a requester device 110 may be a computing device through which a human user or alternate agent (each, a “requester 105”) initiates or manages an interaction with the overall system 100.

In some embodiments, the requester device 110 may be a smart telephone, a tablet computer, a laptop, a desktop workstation, a wearable computer, a voice-activated assistant, or another microprocessor-based platform. Each requester device 110 may include at least one central processing unit (CPU), volatile and non-volatile memory, and in some cases, a user-interface subsystem (for example, a touch-sensitive display, microphone, keyboard, or pointing device), and a communications interface capable of exchanging digital signals over wired and/or wireless links (e.g., Ethernet, Wi-Fi, cellular, Bluetooth, near-field communication, optical, or satellite links). The communications interface enables the requester device 110 to transmit a request message to system 100 and to receive corresponding response data, control codes, acknowledgements, or other information generated or curated by system 100. Requester device 110 may encrypt a request when sending it through network 140 to another part of system 100. Conversely, when response data is returned, the requester device 110 may decrypt, decompress, verify, and render the data for presentation to the requester, or may route the data to a downstream process or storage medium. In certain embodiments the requester device 110 further stores preference settings, credential material, or state information that is supplied to system 100 to personalize or optimize interactions. Any suitably provisioned computing platform can serve as a requester device 110 in a hardware-agnostic manner.

The requester device 110 need not be embodied as a discrete, physically instantiated piece of hardware. In certain embodiments the requester device 110 is implemented as a virtual device—for example, a containerized software component, a server-side microservice, or a cloud-hosted virtual machine—which may expose a programmatic interface such as a RESTful or gRPC application-programming interface (API). The requester 105 entity may be generalized beyond a human operator. In some embodiments the requester 105 is an institutional facility—such as a government agency, news organization, commercial organization, data center, manufacturing plant, or logistics hub—that employs one or more requester devices 110 (physical and/or virtual) to interface with system 100 on a continual or scheduled basis. In some embodiments the requester 105 comprises an autonomous or semi-autonomous virtual agent, such as an artificial-intelligence (AI) bot, robotic process automation (RPA) script, or other machine-based actor, that programmatically determines when and how to initiate requests without direct human intervention. The requester device 110 may act on behalf of an automated workflow to generate request messages destined for system 100. In some embodiment the requester device 110 is another software subsystem—e.g., a microservice, daemon, scheduled job, or third-party application.

In some embodiments, one or more components of the system 100 may communicate via one or more networks 140. For example, the network(s) 140 may facilitate communications among or between the requester device 110, an analyst device 180, one or more third-party platforms 150, one or more third-party data storage units 160, a network 140, one or more overhead data collection devices 170, one or more communication devices 175, one or more analysis platforms 120, and one or more data storage units 135. Network 140 may be or include any one or more wired and/or wireless, local- and/or wide-area network, including one or more enterprise networks and/or the Internet. In some instances, one or more components of system 100 may utilize transport-layer security (TLS), VPN tunnels, post-quantum cryptography, or other cryptographic safeguards, and may utilize authentication, API keys, data logging, or hardware-rooted attestation to provide data provenance and security. In some examples, one or more components of system 100 may check permission levels of the requester 105 to determine the level of data access and analysis appropriate and/or permitted to be released to the requester 105.

The system may include a third-party platform 150 including a third-party platform facility 155 which may operate as an interface through which requests can be exchanged with external service providers. In some embodiments, the platform 150 may relay or originate request messages toward overhead data collection devices 170—for example, orbital satellites, high-altitude balloons, crewed aircraft, or un-crewed aerial vehicles (UAVs)—to task those devices to collect additional data (such as images, thermal, SAR or other data.) In some embodiments, the third-party platform 155 may do one or all of ingesting, decrypting, and integrity-checking data. In some embodiments the third-party platform may perform third-party analytic routines such as object detection, change-detection, digital-surface-model generation, or precision prediction either upon request or prior to forwarding the processed results.

In some embodiments, platform 150 may be any set of computing devices appropriate for the task. Some examples include a rack-mounted or blade server (for instance, incorporating one or more multi-core CPUs, general-purpose GPUs, FPGA or ASIC accelerators, redundant power supplies, and non-volatile storage), an edge gate-way, a modular field unit, or a virtualized service deployed in a public or private cloud.

In some embodiments the system can include a third-party storage unit 160 accessible to the system directly or via platform 150 which may store raw or processed data. System 100 may be configured to access third-party storage units 160 either directly or via the third-party platform 150 (such as via an API) to orchestrate data integration. Nonlimiting examples of relevant third-party data sources may include SAR, EO, RF, open source commercial and defense intelligence, and publicly or commercially available data sources. In some embodiments, the system 100 may be configured to access and integrate private data available through the requester into the data collected and processed for analysis. In some embodiments, the system 100 includes a custom platform that enables on-prem deployment of data integration capabilities by augmenting the premises' existing image processing and cataloging capabilities.

The system may include an overhead data collection device 170 (the “device” 170) which may be accessed (depending on the device 170) either directly or through the communication device 175 via one or more of the analysis platform 120, the network 140, and the third-party platform 150. In some embodiments, an overhead data collection device 170 may be an orbiting or altitude-bound platform—for instance, an Earth-observation satellite, high-altitude pseudo-satellite (HAPS), stratospheric balloon, fixed-wing reconnaissance aircraft, or unmanned aerial vehicle. In some embodiments, the device 170 carries one or more sensor payloads capable of capturing electromagnetic, gravimetric, or radiometric signals. The device 170 may provide altitude-determination and control (such as via reaction wheels, control-moment gyros, star-trackers, GNSS receivers), electrical power subsystems (such as photovoltaic arrays, battery packs, or fuel cells), data-handling avionics, and telemetry, tracking, and command (TT&C) transceivers (which may transmit in S-, X-, or Ka-band or via optical inter-satellite links.) Sensor payloads may include, by way of non-limiting example: panchromatic and multispectral line-scan imagers; hyperspectral imaging spectrometers; synthetic-aperture radar (SAR) assemblies; lidar transceivers; and radio-frequency or electronic-intelligence (ELINT) receivers.

Device 170 may be selected in part based on its orbital regime-such as its revisit-rate, look-angle, and swath-width objectives. For instance, a constellation of low-Earth-orbit (LEO) satellites yields global coverage at sub-daily cadence, whereas geostationary orbits remain over specific regions. Onboard memory units temporarily store detector outputs, which are downlinked to communication device 175. In some embodiments, metadata—such as ephemeris, attitude quaternions, sensor temperature, and calibration coefficients—is attached to each data segment to enable geolocation, orthorectification, and radiometric correction during data processing and analysis.

The system includes a communication device 175 to interface with the overhead data collection device 170. In some embodiments the communication device 175 functions as a relay through which bidirectional data streams and control signals are exchanged with the overhead data collection device 170. Device 175 may be a fixed ground station, a ship-borne or mobile tactical terminal, an aerostat- or aircraft-mounted relay pod or other device capable of receiving a signal from device 170. The communication device may include a tracking and scheduling subsystem that ingests orbital elements or flight-path updates, predicts visibility windows, resolves pointing angles, and hands off between antennas or nodes. The communication device 175 may include an antenna subsystem to track the device 170; a radio-frequency (RF) transceiver chain covering TT&C bands (e.g., S- or UHF), down-link bands (X-, Ku-, Ka-, or V-band), laser-communication terminals optical links; and a baseband processing module.

The system may include an analysis platform 120 (the “platform” 120). In some embodiments, the platform 120 may be responsible for one or more of parsing the requester's 105 query, determining a plan for data collection and analysis, collecting, cleaning, processing, compiling, and analyzing the data, and generating an answer and/or report of the results to the requester 105. In some embodiments, the analytics platform may include data storage units (in some cases including data storage unit 135), processing nodes, communication interfaces, user interface devices, and peripheral devices. The data storage units 135 may be high-speed storage devices, such as solid-state drives (SSDs) or cloud-based databases or datastores, configured to store historical request data, machine learning models, and task execution logs. The processing nodes may be centralized or distributed computing units. The communication interfaces may include wired or wireless communication modules, such as Ethernet, Wi-Fi, Bluetooth, or 5G modems. The user interface device may include GUI-enabled devices, such as tablets and smartphones. The peripheral devices may include sensors, cameras, or other data acquisition tools integrated into the platform.

Platform 120 may include any set of computing devices. Some examples include a rack-mounted or blade server (for instance, incorporating one or more multi-core CPUs, general-purpose GPUs, FPGA or ASIC accelerators, power supplies, and non-volatile storage), an edge gate-way, a modular field unit, portable devices such as smartphones, or a virtualize service deployed across devices or in a public or private cloud. Optional subsystems may include hardware-based key managers (HSMs or TPMs), AI acceleration cards, radio-frequency front-ends (S-band, X-band, Ka-band), or software enabling down-link reception. In some embodiments, the platform may be configured as a distributed architecture, enabling parallel processing and decentralized data management for enhanced computational efficiency. The architecture may include one or more processing nodes connected via wired or wireless communication.

The platform 120 may include facilities to control the functional aspects of platform 120. A secure-communications module may establish authenticated sessions enabling permission-level access to data and analysis tasks, encryption of data and tasks, and bidirectional transfer of data. An ingestion module may accept incoming data via the network, terrestrial fiber, RF down-link, or cloud relay. The platform may include a task-scheduling engine that dispatches acquisition requests to device 170 or third-party platform 150 and may catalog and refer to orbital visibility windows, sensor-mode constraints, service-level agreements, or user-defined policies. The platform 150 may include a governance layer which may log transactions, enforce requester-based access control to data, and trigger compliance checks prior to execution of requester's 105 query.

The analysis platform 120 may include a tasking agent 125. The tasking agent 125 may receive user requests, analyze those requests in the context of historical data and prior requests, and generate a prioritized task list to be executed by the platform 120. The tasking agent 125 may utilize rules-based approaches and/or machine learning techniques, to generate a task list and ensure appropriate resource allocation within the analysis platform 120. The analysis platform 120 may utilize natural language processing (NLP) techniques for query interpretation and task mapping. In some embodiments, the tasking agent may utilize NLP libraries (e.g. spaCy or Hugging Face models) to parse requester 105 queries and identify relevant keywords or contexts. The tasking agent 125 may translate queries into actionable instructions for the analytics agent, determining which data sets, data processing, and analysis techniques to utilize.

The tasking agent may be implemented across one or more devices and structures within the analysis platform 120. In some embodiments, the agent resides on a central processing server. In other embodiments, the agent is distributed across multiple nodes in a decentralized architecture. These nodes may include edge devices, such as IoT gateways or wearable devices, that locally process data before transmitting it to the central hub. The tasking agent may interface with other components, including data storage units, processing nodes, and communication interfaces.

Upon receiving a request, the tasking agent may parse the request to identify its parameters, objectives, and metadata (such as data regarding the identity of requester 105 and permissions.) The agent may compare the received request with a historical database of prior requests and corresponding results stored in a memory structure, such as in data storage unit 135. This comparison allows the agent to identify patterns, trends, and correlations that inform the generation of a task list based on the context and the request. In some embodiments, the tasking agent employs machine learning models, such as neural networks or decision trees, trained on historical data. These models enable the agent to predict task sequences, resource requirements, and time estimates based on prior outcomes. For example, if a request involves analyzing sensor data from a satellite, the tasking agent may recognize that certain preprocessing steps, such as noise reduction or outlier detection, are commonly required for similar analyses. The agent may then automatically include these steps in the task list, along with additional tasks identified by the machine learning model.

In some embodiments, the tasking agent may further incorporate a feedback mechanism based on new data. The tasking agent may monitor the execution of the generated task list and adjust future task generation processes based on observed outcomes. For instance, if certain tasks are found to be redundant or unnecessary based on execution results, the agent may update its machine learning models and task generation logic to reflect new information. In some embodiments, the tasking agent 125 will propose altering the task list to the analyst 190 for approval prior to update.

The platform 120 may include an analytics agent 130. The agent may be implemented across one or more devices and structures within the analytics platform. In sine embodiments, the agent resides on a central processing unit. In other embodiments, the agent is distributed across multiple nodes in a decentralized architecture. In some embodiments, the analytics agent 130 may be built on processing units such as GPUs (Graphics Processing Units) and TPUs (Tensor Processing Units) to accelerate data analysis for tasks involving large datasets or computationally intensive machine learning models. These processing units may be integrated into a service system allowing the analytics agent to handle parallel workloads and scale analysis. The servers may be connected to data storage units such as data storage unit 135 which may store one or more of the machine learning models, historical data, intermediate results, and training dataset. In some embodiments, the analytics agent software may include a data normalization and preprocessing module to handle diverse data types, including structured data from relational databases and unstructured data such as images or text. The module may utilize libraries and tools for data processing (e.g. Pandas, OpenCV) or specialized software for geospatial data processing, such as GDAL (Geospatial Data Abstraction Library), to extract relevant features.

In some embodiments, analytics agent 130 may use rule-based processing to perform one or more data analysis steps. Analytics agent 130 may include one or more rule-based engines based on a logic-based programming framework or open-source library, or custom rules engine built from, or relying on, one or more playbooks. A playbook may be called a rule book and the terms playbook and rulebook may be used interchangeably herein. A playbook may include one or more sets of operations for data collection and analysis. The engine may interface with a library of playbooks, which may be stored in a database such as data storage unit 135 and dynamically loaded depending on the analytical task. The structure of the playbooks may allow for updates, enabling new rules and/or playbooks to be added or existing rules to be modified. The engine may integrate with the machine learning module to combine deterministic insights with probabilistic predictions.

In some embodiments, playbooks may be added or updated to system 100 to add functionality and allow system 100 to analyze new requests. The playbook may be selected based on situational indicators. The system 100 may determine that a new request is based on new indicators. Playbooks for new indicators may be added to system 100 by utilizing one or more of: playbooks for similar requests; analyst or other human input; and an external playbook submitted for that indicator to the system 100. When a new indicator is presented to system 100, the system 100 may flag analyst 190 regarding the new indicator. To determine an appropriate playbook, system 100 may do one or more of: (1) present analyst 190 with a proposed playbook (for instance, by using a playbook associated with a similar indicator or a playbook it was supplied with by the requester or another party), (2) work with the analyst 190 to develop a playbook for the new indicator, or (3) receive a playbook from a requester 105, analyst 190, or other source. In some embodiments, once a proposed playbook has been approved, for instance by the analyst 190 or requester 105, it is added to data storage unit 135 and associated with the new indicator.

In some embodiments the analytics agent 130 may include one or more machine learning engines. The machine learning engine may be built using frameworks (for example TensorFlow, PyTorch, or Scikit-learn) and libraries. In some embodiments, the analytics agent 130 may include pre-trained models for certain tasks, as well as the capability to train new models on domain or use-specific datasets or on requester 105-specific datasets. The analytics agent 130 may track model versions, training datasets, and performance metrics. The analytics agent 130 may synthesize the results into structured outputs and generate reports and summaries. In some embodiments, analytics agent 130 may integrate with the communication device 175 and network interfaces to receive data. Analytics agent 130 may collect, compile, process and analyze diverse types of data, including historical records, data retrieved from internal and third-party databases, and data generated by device 170.

While agents 125, 130 are described and illustrated in connection with FIG. 1 as agents, it should be appreciated that embodiments are not limited to operating with agents. The functionality described in connection with agents 125 and 130 may be implemented in other embodiments as other suitable software executing as hardware, such as any other form of software facility.

In some embodiments, system 100 may include one or more data storage units 135, which optionally may be part of analysis platform 120. The data storage units 135 may store the historical data used by the tasking agent 125 and analytics agent 130, machine learning models, and raw and/or processed data collected from one or more third-party data units and devices 170. In some embodiments, the storage units 135 may employ secure, policy controlled data exchange channels. For instance, the storage units 135 may track the ingress and egress of data as well as the data lineage and control appropriate data access based on requester identity. In some embodiments, the storage unit 135 may incorporate built-in indexing and query acceleration to speed up data retrieval. In some embodiments, the storage until 135 may include on device compute modules such as preliminary filtering, tiling, or inferencing to reduce data latency.

In some embodiments, the system may include an analyst device 180 through which a human analyst 190 may interface with system 100, ensuring there is a human in the loop. The analyst device may be designed to interface with human analysts for reviewing, validating, and refining the results generated by the tasking agent 125 and the analytics agent 120, as well as for submitting queries, adapting tasks, approving new playbooks, or requesting updates to ongoing analyses. The device may include a software interface, analyst device facility 185, for facilitating collaboration between analyst 190, tasking agent 125 and analytics agent 130. The physical device may be of any form factor, examples of which include a workstation, mobile computing device and smart phone.

In some embodiments, the analyst device facility 185 may include a graphical user interface (GUI) and may provide tools for accessing, reviewing, and annotating the results produced by the tasking agent 125 and/or the analytics agent 130. The interface display data may be output in a variety of formats, such as charts, graphs, tables, and geospatial visualizations, depending on the nature of the analysis. Analysts may use the interface to mark sections of data for further investigation, flag inconsistencies, or add contextual notes. The facility may allow analysts to submit follow-up questions or requests for updates to the tasking agent 125 and/or analytics agent 130. System 100 may be configured to interpret free-text queries (such as via natural language processing) and translate them into actionable instructions for the analytics agent. Facility 185 may be configured to track changes made to the analysis, generating an audit trail and providing decision-making tracking.

In some embodiments, the analyst device 180 may incorporate communication modules for collaboration between multiple analysts. These modules may enable real-time sharing of insights, results, and annotations across a team. For example, integration with collaborative platforms like Slack or Microsoft Teams may be provided to allow analysts to share findings and coordinate analysis. Moreover, the analyst device may be equipped with security features, such as user authentication and encryption protocols appropriate to the sensitivity of the data.

FIG. 2 is a flowchart of an illustrative method 200 for generating situational awareness through obtaining and analyzing geospatial data, in accordance with some embodiments of the technology described herein. In block 210, system 100 may receive a query, such as a description of a goal. The query may describe or suggest a goal that a user wishes to accomplish. In accordance with techniques described herein, the system may process the query to determine how to respond to the query, including what data is to be collected and of what, and how the data is to be analyzed, so as to respond to the query. As discussed above, this functionality of interpreting the query and determining operations that are to be performed in response may yield a higher-performance and higher-quality result, particularly as queries from users tend to be non-specific in terms of their needs or, in some cases, describing actions to be taken that may be unproductive for accomplishing a goal. Through using the process of FIG. 2, the goal underlying the query can be determined, and operations to be performed responsive to the query can be identified and then taken.

The query may be submitted by a requester 105 via requester device 110. The requester 105 may be an individual user, an automated program, or any other device capable of initiating and transmitting a request for data collection, processing, or related operations. In some embodiments, the requester 105 may input various types of natural language requests into the geospatial system 100. In some embodiments, the requester 105 may specify parameters for data aggregation, filtering, or analysis, such as setting thresholds for alerts, or generating or uploading predictive models based on historical data trends. In some embodiments, the requester 105 may rank the importance of certain parameters, such as speed of receiving analysis, overall cost of analysis, or accuracy of results. In some embodiments, the requester may be an automated program and the system 100 may facilitate machine-to-machine communications The automated program may utilize preconfigured instructions to dispatch requests to the geospatial system 100, specifying parameters such as collection scope, filters, timing constraints, and intended use cases. Further description of embodiments of block 210 is set forth in blocks 310, 610 and 710 described herein below.

In block 220, system 100 may process the query using at least one model to identify one or more playbooks. The playbook may be a set of operations for data collection and analysis and associated with a domain. Domains may include particular areas of interest, such as maritime, naval, human interaction, natural disaster, or others. Domains may additionally or alternatively include particular problems, questions, or techniques, such as following the custody chain in illegal oil trade, determining economic activity based on structural or site changes, assessing the probability of a future flight path based on observed human activity, or determining the path of wildfire based on observed weather and terrain observations. As will be appreciated from the discussion below of use of a playbook, by identifying the playbook(s) that are related to a query, the system determines a domain of the query and determines operations for data collection and analysis that may be used in responding to the query.

The playbook(s) may be identified through using the model(s) in various ways. In some embodiments, for example, processing the query using the model(s) to identify one or more playbooks may include techniques such as determining the closest rulebook by matching one or more semantic tags. The model(s) may determine one or more semantic tags associated with the query and match it to one or more semantic tags associated with a playbook. The semantic tags may be determined to be associated with the query through appearing in the query, such as words or phrases used in the query that are identified as tags, or as meanings surfaced from or other metadata derived from words or phrases used in the query. Semantic tags relate to domains of playbooks, and thus may be usable to identify the playbook(s) related to the query and that are to be used to process the query. For instance, if the query is related to ships, the model(s) may determine that a maritime tag is relevant to the query. In this case, the model(s) may determine that the maritime playbook is most likely to contain the relevant operations for data collection and analysis and match the query to that playbook. Other techniques for matching the query to the playbook may be used, such as those described herein including matching the query to the closest query the system has already answered and utilizing the playbook matched to that query.

In some embodiments, data other than the query itself may be processed together with the query, or separately used alongside the query, so as to determine the playbook(s). For example, in some embodiments the system 100 may determine geocoding data from the query, such as the time of interest or the area of interest. The system may then analyze such geocoding data as a part of matching a query to a playbook. For example, if the geocoding data determined from the query indicates a location that is a known oil facility such as a storage site or refinery, the system 100 may determine a semantic tag associated with oil or otherwise match the query to a playbook related to an oil domain.

In some cases, the system may identify potential matches between the query and one or more playbooks, from a set of available playbooks. Potential matches may be scored by the system in terms of a degree of match or confidence of match, using any suitable calculations for such categorization of the query or classification of the query. In some embodiments, a highest-scoring playbook may be selected as a match, or a highest-scoring playbook if the score is above a threshold. In other embodiments, one playbook may be selected if its score is above a threshold difference from the second-highest (or otherwise next-highest) scoring playbook, and/or if its score is above a second threshold. In other embodiments, if multiple playbooks are found to have a match score above a threshold or are above a threshold difference with a next-highest scoring playbook, the system may determine each of those playbooks to be a match and select multiple playbooks to analyze the query.

In some embodiments the system maintains a request-history library, implemented, for example, within data storage unit 135, in which every previously received request record is stored with metadata (time stamp, requester identifier, request parameters, and outcome codes) and the playbook matched to the query. The system may utilize RAG and semantic similarity matching to the library of past queries to analyze the request. In some embodiments, the system may use third-party software such as Open AI, Llama, Grok, Claude, Gemini or others and may determine a confidence interval for the best match playbook. If the confidence interval is below a set threshold, the system 100 may abort the sequence and return an error or may flag for analyst 190 or requester 105 review.

In some embodiments, each query may be passed through a feature-extraction pipeline to generate a feature vector. The vector may be stored alongside the raw request in an indexable structure. To accelerate look-ups, the library may include one or more similarity search structures such as metric-tree indices (e.g., KD-trees, ball trees, or vantage-point trees), approximate nearest-neighbor graphs (e.g., HNSW), or locality-sensitive hashing. Upon receiving a new request, the tasking agent may determine a query vector using the feature extraction pipeline, then executes a nearest neighbor search against the indexed repository. The engine may return the closest task, which may be the historical request query whose stored vector exhibits the minimum distance along with a ranked list of K-nearest neighbors. A similarity score may be derived which may be used by the tasking agent to determine whether to flag or abort the query. After the system has determined the top-K candidate requests, the tasking agent may use RAG to combine the textual or structured content of the new request, and condensed “context snippets” extracted from each candidate request, into a prompt passed to a large-language model which may generate a semantic similarity score. The system may further determine a confidence metric with respect to the semantic similarity score. Once the nearest query is determined, the playbook previously matched to that query may be selected as the playbook for the new query.

In some embodiments, if such criteria for selecting a playbook are not met, the system may determine it does not have an adequate match to a playbook. In such a case, the system may in some embodiments prompt a user to provide more information about the query.

Additionally or alternatively, in some embodiments, if the system does not have an adequate match to a playbook, the system 100 may process the query using the model(s) to break the query down into multiple queries in order to better match the multiple queries to multiple playbooks. The system 100 may select multiple playbooks with the multiple playbooks selected based on different aspects of the natural language query. If the system 100 determines that a match to a playbook has not been made (for example, if the confidence interval of a match between the query and the playbook is too low), the system 100 may present the requester 105 with one or more candidate playbooks and allow the requester 105 to select a playbook to use for analysis. The system 100 may also provide the requestor 105 with confidence intervals or perceived strengths and weaknesses of a particular playbook for the submitted query. The requestor 105 may select a playbook to run or may determine that no playbook matches sufficiently. The requestor 105 may elect not to run any analysis on the query or may submit a new playbook or request a modification to a current candidate playbook to better fit the query.

In some embodiments, the system 100 may generate a new playbook based on the query. The new playbook may be presented to a reviewer for approval. For example, the new playbook may be presented to the requestor 105 or an analyst 190. If the requestor 105 or analyst 190 approves the new playbook, the new playbook may be used for the analysis and/or added to the set of playbooks utilized for future queries.

Further description of embodiments of block 220 is set forth in blocks 320, 620, 720 and 2010 described herein below.

In block 230, system 100 may identify data to be collected to respond to the query. As noted above, each playbook relates to a domain and identifies operations for data collection and analysis to be used in responding to queries in that domain. As such, when the playbook(s) are identified, the playbook(s) can be used to identify the data that is to be collected, and the operations to be performed for such data collection, for generating a response to the query. Accordingly, in block 230, the system 100 may use the playbook(s) and/or information in the query to identify data that is to be collected in response to the query. Each playbook may set out relevant information or techniques for assessing abstract or complex queries using observable data known to impact or correlate with the query. In addition to the playbook operations, information from the query itself may be used to identify the query. As should be appreciated from the foregoing, a playbook may identify operations that are to be used in performing data collection and analysis for queries that relate to a domain. The operations of the playbook may be customized or tweaked based on content of the query or content determined from the query, which in some cases may be determined from the query using information contained in the playbook. For example, if the playbook indicates that an area of interest or time of interest is to be determined from the query, that information may be used in identifying data to be collected or from where. If the query uses keywords or describes information about the goal, that information may be used together with the operations of the playbook to set goals, including in some cases consistent with instructions from the playbook of what information from the query is to be used. In some cases, if the playbook indicates information that should be set out in the query and that is to be used, and the query does not set out that information, the user may be prompted to provide that information. One or more models may break down the query into multiple queries to use the operations for data collection and analysis contained within the playbook.

Further description of embodiments of block 230 is set forth in blocks 410, 630, and 2020 described herein below.

In block 240, system 100 may identify data sources for the data that is to be collected. In some cases, data may be available from multiple sources, including data that was previously captured and may be available in a data set in storage or data that may be captured in response to the query, such as tasking a satellite or other tool to capture the data. The tasking agent 125 may refine the data collection and analysis methodology based on previous data collected and stored in data storage unit 135.

In some embodiments the tasking agent 125 may return a proposed data collection and analysis methodology to one or more of the requester 105 and analyst 190 for input. In some examples, system 100 may present to the requester an analysis objective and display recommended monitoring objectives based on the problem set and solicit feedback from the requester to select the objectives from the list or input alternate objectives. The system 100 may generate a cost based on the selected objectives and data to be collected and on information regarding cost of access or capture of data, and ask for approval from the requester 105 or analyst 190 or other person to incur the cost for generating a response to the query. Further description of embodiments of block 240 is set forth in blocks 430, 640, 810, and 2020 described herein below.

In block 250, system 100 may collect the data from the one or more data sources. System 100 may utilize the data collection methodology set out by the tasking agent 125 (as may have been adapted by the requester 105 and/or analyst 190) to collect the data. In some embodiments, the tasking agent 125 may query the data storage unit 135 to collect data housed in the data storage unit 135 and interface with third-party platforms to secure access to data in third-party platforms 160. In some cases, the tasking agent 125 may also submit tasks to overhead data collection devices 170 directly through communication device 175 of via a third-party platform 150. Further description of embodiments of block 250 is set forth in blocks 430, 440, 640, 820, and 2030 described herein below.

In block 260, system 100 may analyze the collected data. Analytics agent 130 may analyze the data based on the methodology set out by the tasking agent 124 (as may have been adapted by the requester 105 and/or analyst 190), which may have been influenced by the playbook(s) identified for the query and the operations identified therein. The analytics agent 130 may compile, clean, and otherwise process the data and perform analysis based on the rules-based agent and/or machine learning agent. In some embodiments, if, during the course of analysis, the analytics agent 130 determines that integral data is missing, it may refer to the tasking agent 124 to collect more data and/or may flag this for the requester 105 and/or analyst. In some embodiments, once the analytics agent 130 completes analysis, it sends the response to analyst 190 to review, refine, and signoff on the analysis, ensuring a human in the loop. Further description of embodiments of block 260 is set forth in blocks 450, 650, 820, 230 and 240 described herein below.

In block 270, system 100 may generate and output a report based on the collected data and analysis of the collected data which may be in natural language text. In some examples, one or more models may be used to generate the report which may be the same model as the model used in block 220 to process the query or a different model. In some examples, the report may be sent to the requestor 105, for instance via a GUI or report file. The system 100 may return the report and/or the analysis to the requester. In some embodiments, the system returns a confidential interval, sufficiency gaps and threshold and suggests next steps. The requester 105 may accept the analysis, request additional analysis, request further data collection and analysis, or submit a new query.

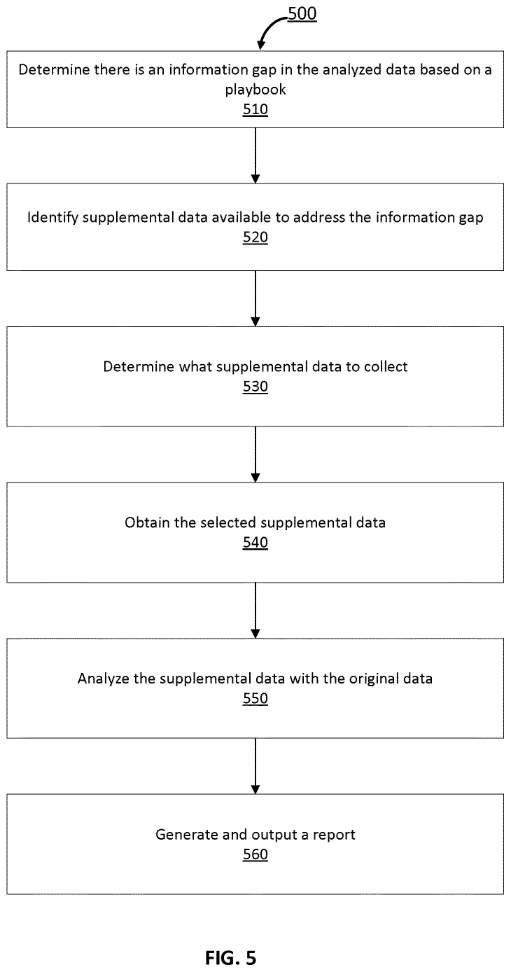

In some embodiments, the system 100 may determine there is an information gap, as described in FIG. 5 below. System 100 may perform one or more of the blocks in FIG. 5 in response to determining there is an information gap. In some examples, the system may return a confidential interval and suggests next steps. The requester 105 may accept the analysis, request additional analysis, request further data collection and analysis, or submit a new query. The system 100 may determine based on a draft of the report that supplemental data would be beneficial for at least a portion of the analysis. The system may alternately or additionally determine based on the playbook that supplemental data would improve at least a portion of the analysis. The system may inform the requestor 105 of the improvement to be gained by supplemental data and optionally collect and analyze the supplemental data combined with the original data. Further description of embodiments of block 270 is set forth in blocks 460, 630, 850, 2050, and 2060 described herein below.

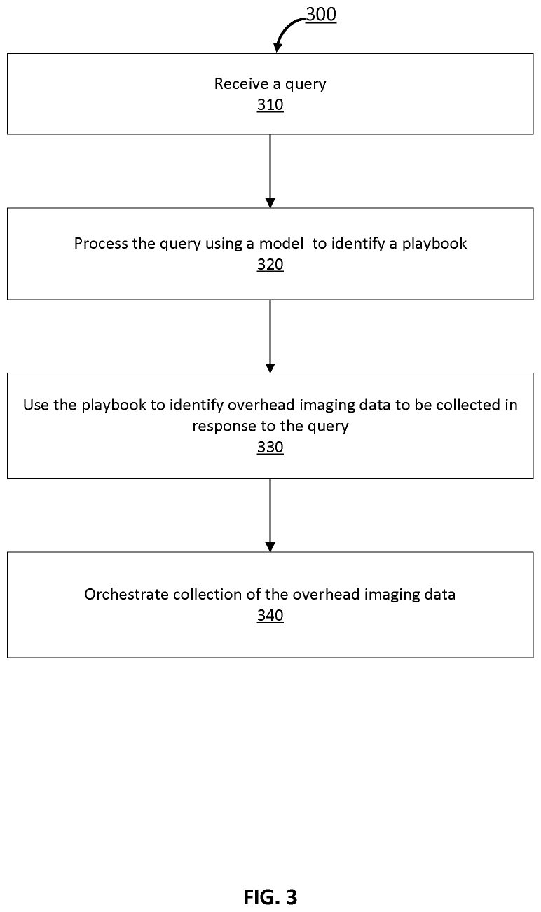

FIG. 3 is a flowchart of an illustrative method 300 for generating situational awareness through obtaining and analyzing geospatial data, in accordance with some embodiments of the technology described herein. In block 310, system 100 may receive a query. The query may be submitted by a requester 105 via requester device 110. The requester 105 may be an individual user, an automated program, or any other device capable of initiating and transmitting a request for data collection, processing, or related operations. In some embodiments, the requester 105 may input various types of natural language requests into the geospatial system 100. In some embodiments, the requester 105 may specify parameters for data aggregation, filtering, or analysis, such as setting thresholds for alerts, or generating or uploading predictive models based on historical data trends. In some embodiments, the requester 105 may rank the importance of certain parameters, such as speed of receiving analysis, overall cost of analysis, or accuracy of results. In some embodiments, the requester may be an automated program and the system 100 may facilitate machine-to-machine communications The automated program may utilize preconfigured instructions to dispatch requests to the geospatial system 100, specifying parameters such as collection scope, filters, timing constraints, and intended use cases. Further description of embodiments of block 310 is set forth in blocks 210, 610 and 710 described herein.

In block 320, system 100 may process the query to identify a playbook, for instance by using a model such as a large language model. The playbook may be a set of operations for data collection and analysis and associated with a domain. Domains may include particular areas of interest, such as maritime, naval, human interaction, natural disaster, or others. Domains may additionally or alternatively include particular problems, questions, or techniques, such as following the custody chain in illegal oil trade, determining economic activity based on structural or site changes, assessing the probability of a future flight path based on observed human activity, or determining the path of wildfire based on observed weather and terrain observations. As will be appreciated from the discussion below of use of a playbook, by identifying the playbook(s) that are related to a query, the system determines a domain of the query and determines operations for data collection and analysis that may be used in responding to the query.

The playbook(s) may be identified through using the model(s) in various ways. In some embodiments, for example, processing the query using the model(s) to identify one or more playbooks may include techniques such as determining the closest rulebook by matching one or more semantic tags. The model(s) may determine one or more semantic tags associated with the query and match it to one or more semantic tags associated with a playbook. The semantic tags may be determined to be associated with the query through appearing in the query, such as words or phrases used in the query that are identified as tags, or as meanings surfaced from or other metadata derived from words or phrases used in the query. Semantic tags relate to domains of playbooks, and thus may be usable to identify the playbook(s) related to the query and that are to be used to process the query. For instance, if the query is related to ships, the model(s) may determine that a maritime tag is relevant to the query. In this case, the model(s) may determine that the maritime playbook is most likely to contain the relevant operations for data collection and analysis and match the query to that playbook. Other techniques for matching the query to the playbook may be used, such as those described herein including matching the query to the closest query the system has already answered and utilizing the playbook matched to that query.

In some embodiments, data other than the query itself may be processed together with the query, or separately used alongside the query, so as to determine the playbook(s). For example, in some embodiments the system 100 may determine geocoding data from the query, such as the time of interest or the area of interest. The system may then analyze such geocoding data as a part of matching a query to a playbook. For example, if the geocoding data determined from the query indicates a location that is a known oil facility such as a storage site or refinery, the system 100 may determine a semantic tag associated with oil or otherwise match the query to a playbook related to an oil domain.

In some cases, the system may identify potential matches between the query and one or more playbooks, from a set of available playbooks. Potential matches may be scored by the system in terms of a degree of match or confidence of match, using any suitable calculations for such categorization of the query or classification of the query. In some embodiments, a highest-scoring playbook may be selected as a match, or a highest-scoring playbook if the score is above a threshold. In other embodiments, one playbook may be selected if its score is above a threshold difference from the second-highest (or otherwise next-highest) scoring playbook, and/or if its score is above a second threshold. In other embodiments, if multiple playbooks are found to have a match score above a threshold or are above a threshold difference with a next-highest scoring playbook, the system may determine each of those playbooks to be a match and select multiple playbooks to analyze the query.

In some embodiments, if such criteria for selecting a playbook are not met, the system may determine it does not have an adequate match to a playbook. In such a case, the system may in some embodiments prompt a user to provide more information about the query.

Additionally or alternatively, in some embodiments, if the system does not have an adequate match to a playbook, the system 100 may process the query using the model(s) to break the query down into multiple queries in order to better match the multiple queries to multiple playbooks. The system 100 may select multiple playbooks with the multiple playbooks selected based on different aspects of the natural language query. If the system 100 determines that a match to a playbook has not been made (for example, if the confidence interval of a match between the query and the playbook is too low), the system 100 may present the requester 105 with one or more candidate playbooks and allow the requester 105 to select a playbook to use for analysis. The system 100 may also provide the requestor 105 with confidence intervals or perceived strengths and weaknesses of a particular playbook for the submitted query. The requestor 105 may select a playbook to run or may determine that no playbook matches sufficiently. The requestor 105 may elect not to run any analysis on the query or may submit a new playbook or request a modification to a current candidate playbook to better fit the query.

In some embodiments, the system 100 may generate a new playbook based on the query. The new playbook may be presented to a reviewer for approval. For example, the new playbook may be presented to the requestor 105 or an analyst 190. If the requestor 105 or analyst 190 approves the new playbook, the new playbook may be used for the analysis and/or added to the set of playbooks utilized for future queries. Further description of embodiments of block 320 is set forth in blocks 220, 620, 720 and 2010 described herein below.

In block 330, system 100 may identify data to be collected to respond to the query. The system 100 may use the playbook to identify data in response to the query. The playbook may set out relevant information or techniques for assessing abstract or complex queries using observable data known to impact or correlate with the query. One or more models may use the playbook may break down the query into multiple queries to use the operations for data collection and analysis contained within the playbook. Further description of embodiments of block 330 is set forth in blocks 230, 410, 630, and 2020 described herein below.

In block 340, system 100 may orchestrate the collection of overhead imaging data, such as via the systems and methods described herein.

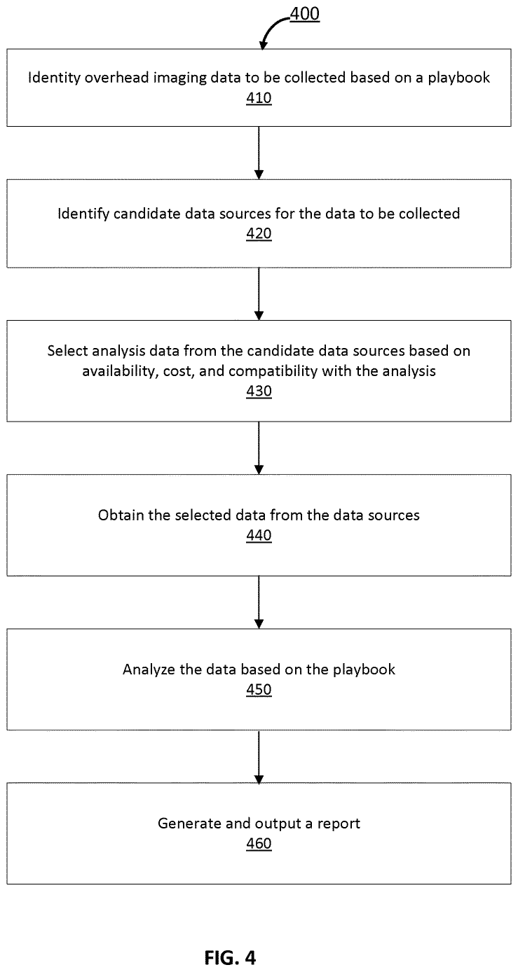

FIG. 4 is a flowchart of an illustrative method 400 for generating situational awareness through obtaining and analyzing geospatial data, in accordance with some embodiments of the technology described herein. In block 410, system 100 may identify geospatial data (for example, overhead data) to be collected to respond to the query. The system 100 may use the playbook to identify data in response to the query. The playbook may set out relevant information or techniques for assessing abstract or complex queries using observable data known to impact or correlate with the query. One or more models may use the playbook may break down the query into multiple queries to use the operations for data collection and analysis contained within the playbook. Further description of embodiments of block 410 is set forth in blocks 230, 630, and 2020 described herein below. The system may leverage previously completed tasks or apply a rules-based engine to apply the playbook operations to the new query. The system may additionally or alternately leverage machine learning techniques to determine a task list or supplement the analysis operations.

In some embodiments, the system may incorporate a machine learning model trained on historical task data which may be used to augment the tasks and operations from the playbook. For instance, the system may determine that a greater quantity of data would be beneficial to increase statistical confidence of the data analysis, or may suggest utilizing specific databases which historically have been more quickly accessible based on urgency of the query. In another example, the system may suggest certain initial reporting formatting or analysis styles and cost/confidence ratio due to previous requester preferences.

In block 420, system 100 may identify candidate data sources for the data to be collected. The tasking agent 125 may refine the data collection and analysis methodology based on previous data collected and stored in data storage unit 135. In some embodiments the tasking agent 125 may return a proposed data collection and analysis methodology to one or more of the requester 105 and analyst 190 for input. In some examples, system 100 may present to the requester an analysis objective and display recommended monitoring objectives based on the problem set and solicit feedback from the requester to select the objectives from the list or input alternate objectives. The system 100 may generate a cost based on the selected objectives and data to be collected. Further description of embodiments of block 420 is set forth in blocks 240, 430, 640, 810, and 2020 described herein below.

In some embodiments, system 100 may provide a breakdown of costs, benefits, and constraints associated with accessing and incorporating additional datasets or conducting additional or advanced analyses. System 100 may pair its recommendation with metrics, such as estimated cost and latency for data retrieval or collection, computational requirements for integrating the data, and the potential impact of incorporating the data on task list accuracy or execution feasibility. For example, if the requester selects high-resolution geospatial data collected via satellite from a specific location, the system 100 quantifies the monetary cost of commissioning image capture, determines when the device 170 is accessible for commissioning and associated time lag, quantifies the storage and processing requirements, and calculates the increase in cost, time delay, and precision compared to using publicly available datasets.

System 100 may compile a catalog of potential data sources and attributes such as cost. System 100 may, for instance, assign zero marginal cost for internal repositories. In contrast, third party commercial databases may be annotated with pricing models (e.g. per-API call, or per-gigabyte) as well as latency and reliability statistics. On-demand overhead devices 170 (e.g., electro-optical or SAR satellites) may be annotated with predictive availability windows, angle limitations, and cost. Additionally, the entries may store data around latency and access, such as which requester types may access the data.

For on-demand data collection, such as for collection of additional satellite data, the system 100 may generate a collection request plan specifying factors such as sensor, time slot, geometry, and downlink channel. For instance, in the case of satellites, the system may compare competing satellite operators, factoring in cost and latency. If the projected cost exceeds the requester's limit, the engine may explore cheaper alternatives (e.g., coarser spatial resolution or older imagery) and resubmit an alternate plan to the requester or notify the requester that the task cannot be completed under the current cost parameters.

In block 430, system 100 may select analysis data from the candidate data sources based on availability, cost, and compatibility with the analysis. System 100 may utilize the data collection methodology set out by the tasking agent 125 to collect the data.

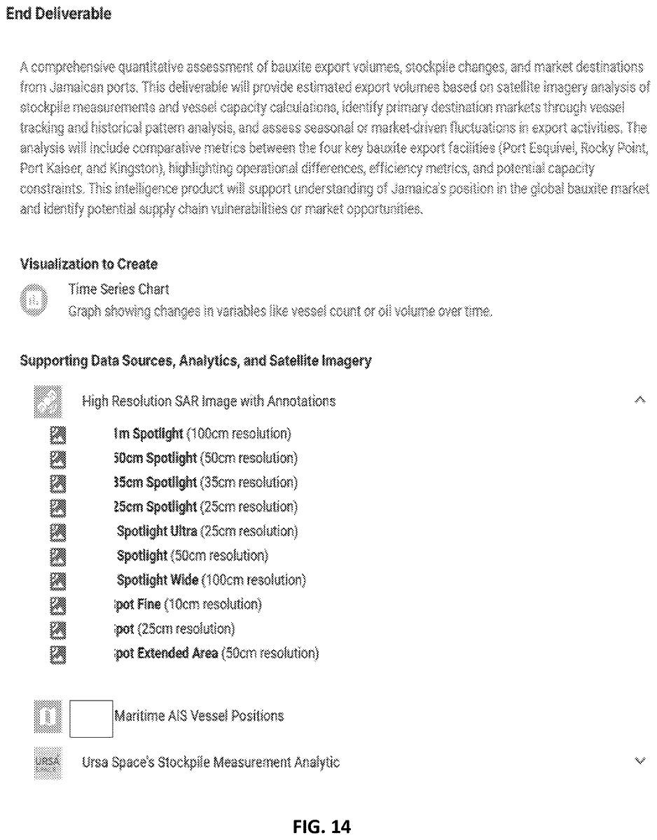

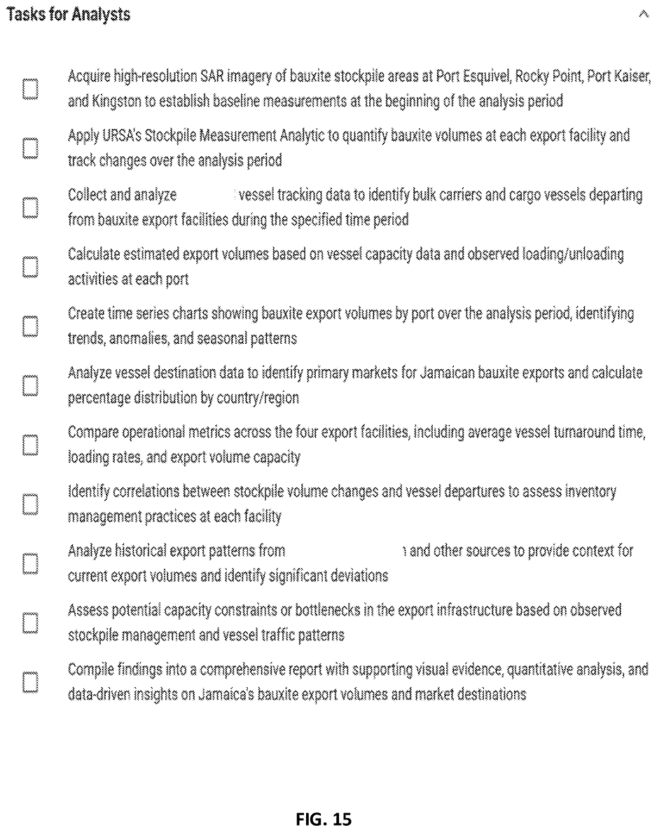

The system may provide the requester with a generated task list such as the one in FIG. 15, optionally accompanied by supporting data, proposals, or analytical insights. In some embodiments, the system may provide instructions from the rulebook, the pre-fetch information, and recommendations on tasking and downstream processing. For example, FIG. 15 displays a GUI interface showing recommended tasks for analysts based on the requester's query. In some embodiments, the system may provide the requester with a list of data sources it recommends utilizing (and may optionally display the data associated with the data source.) For example, FIG. 14 shows recommended data sources to utilize for the requester's query.

Additionally, system 100 may suggest methods of optimizing the data collection and analysis. The system may query the historical data including the task descriptions, completion times, priorities, and contextual factors. By analyzing this data, the system 100 may identify patterns and dependencies among tasks, enabling it to predict and recommend an optimized sequence of tasks for future workflows. The model may refine its predictions based on user feedback and newly completed tasks, increasing efficiency and performance.

Further description of embodiments of block 430 is set forth in blocks 250, 440, 640, 820, and 2030 described herein below.

In block 440, the system may obtain the selected data from the data sources using any of the techniques described herein. For example, the system 100 may obtain data from various free, private, and commercial databases utilizing multiple application programming interfaces. In the event that data is not available, the system 100 may task equipment such as satellites to collect the missing data, and/or send a proposal and cost estimate to the requestor regarding the data required to be collected and the amount of the analysis that could be completed without the collected data.

In some embodiments, the tasking agent 125 may query the data storage unit 135 to collect data housed in the data storage unit 135 and interface with third-party platforms to secure access to data in third-party platforms 160. In some cases, the tasking agent 125 may also submit tasks to overhead data collection devices 170 directly through communication device 175 of via a third-party platform 150.

The system may query internal data repositories which may index based on factors such as geolocation, resolution, and time. In some embodiments, the system may access third-party databases via API integrations, enabling automated querying, retrieval, and delivery of data. They system may generate API requests based on the requester's task description. After querying the external database, system 100 may process the data to ensure relevance and usability.

In some embodiments, when existing data sources (internal or third-party) do not contain the necessary data, the system can initiate new data collection through device 170. In some embodiments, the tasking agent 125 may query the device owner to identify device availability. Using prediction models, the system may estimate the success probability of a task, time constraints, and cost. For example, if the requester specifies high-resolution optical imagery of a particular region, the system may evaluate multiple options by comparing orbital path predictions, response latency, and coverage suitability. Once the device 170 has been selected, the system may establish communication with one or more of the device 170, the communication device 175, and the third-party platform 150 to retrieve the data after collection.

Further description of embodiments of block 440 are set forth in blocks 260, 640, 830, and 2040 described herein below.

In block 450, system 100 may analyze the collected data. Analytics agent 130 may analyze the data based on the methodology set out by the tasking agent 124 (as may have been adapted by the requester 105 and/or analyst 190). The analytics agent 130 may compile, clean, and otherwise process the data and perform analysis based on the rules-based agent and/or machine learning agent. In some embodiments, if, during the course of analysis, the analytics agent 130 determines that integral data is missing, it may refer to the tasking agent 124 to collect more data and/or may flag this for the requester 105 and/or analyst. In some embodiments, once the analytics agent 130 completes analysis, it sends the response to analyst 190 to review, refine, and signoff on the analysis, ensuring a human in the loop.

In some embodiments, the analytics agent may utilize rule-based processing, machine learning analysis, or both. The rule-based processing may use a predefined set of conditions, heuristics, and deterministic models tailored to the specific analytical tasks, such as the operations set out in the selected playbook matched to the query. The rules may apply known operations and data analysis techniques for a given domain. The rules may filter, classify, and prioritize data based on known patterns or conditions. For instance, the rule-based engine might apply conditional logic to identify anomalies in time-series data or to segment areas of interest within satellite images. This rule-based process may be set out in the playbook selected during task definition.

In some embodiments, the analytics agent may additionally or alternately utilize a machine learning engine to uncover patterns and generate predictive insights. For example, the machine learning engine may be used to fill in gaps between the applied rules from the playbook or to adapt the playbook's operations to the query. Alternately or additionally, the playbook may contain settings for training or adapting the machine learning model, such as context to insert into the context window. The machine learning engine may employ supervised learning models for tasks such as regression or classification, unsupervised learning models for clustering or anomaly detection, and neural networks for tasks like image recognition. These models may be trained on relevant datasets and adapted through retraining. In some instances, the selection of the appropriate machine learning engine may be set out in the rulebook selected during task definition. In some instances, the machine learning insights may be utilized by an analyst 190 or other party to update a rulebook or generate a new rulebook to a new query without a rulebook.

In some embodiments, the analytics engine 130 may use object classification techniques to identify, categorize, and extract the relevant features from datasets. The classifiers may use machine learning models, such as Convolutional Neural Networks (CNNs), Decision Trees and Support Vector Machines (SVMs) to distinguish between various types of objects, patterns, or anomalies present in overhead imagery and related datasets. For instance, object classification algorithms trained on overhead imagery datasets may be used to identify features like buildings, roads, vehicles, vegetation, water bodies, or specific objects of interest. For example, the classifier can identify vehicles on highways for traffic management or detect changes in construction progress for project monitoring. In some embodiments, the analytics agent 130 may optimize the object classification model based on parameters associated with the collected imagery. These parameters may include image resolution, spectral band configuration, atmospheric conditions, and geographic region. In some embodiments, object classification may involve combining machine learning models with rule-based classifiers based on the task parameters. For example, in disaster response scenarios, rules may prioritize the identification of damaged infrastructure over intact structures.

In some embodiments, once the initial object classification is performed, the analytics agent may review the analysis to assess the accuracy, relevance, and reliability of the classified objects. Confidence scores may be assigned to each classified object based on the probability that the classification is correct. Objects that fall below a predetermined confidence threshold may be flagged for reclassification using alternate techniques analyst 190 review, or additional training datasets. In some cases, the classified data may be validated through statistical and contextual analysis by comparing the extracted features with known benchmarks or reference datasets. For example, if the object classifier is identifying urban structures from satellite images, the system may cross-check the location, geometry, and layout of these structures against maps and urban planning databases.

In some embodiments, the analysis and results may be reviewed internally by analyst 190 prior to completion. The analyst 190 may perform quality check and additional analysis and interpret ambiguous elements. For instance, the analyst may inspect low-confidence classifications flagged by the system to verify object detection results and include commentary or suggested next steps in the final report.

Further description of embodiments of block 450 is set forth in blocks 260, 650, 820, 230 and 240 described herein below.

In block 460, system 100 may generate and output a report based on the collected data and analysis of the collected data which may be in natural language text. In some examples, one or more models may be used to generate the report which may be the same model as the model used in block 220 to process the query or a different model. In some examples, the report may be sent to the requestor 105, for instance via a GUI or report file. The system 100 may return the report and/or the analysis to the requester. In some embodiments, the system returns a confidential interval, sufficiency gaps and threshold and suggests next steps. The requester 105 may accept the analysis, request additional analysis, request further data collection and analysis, or submit a new query.

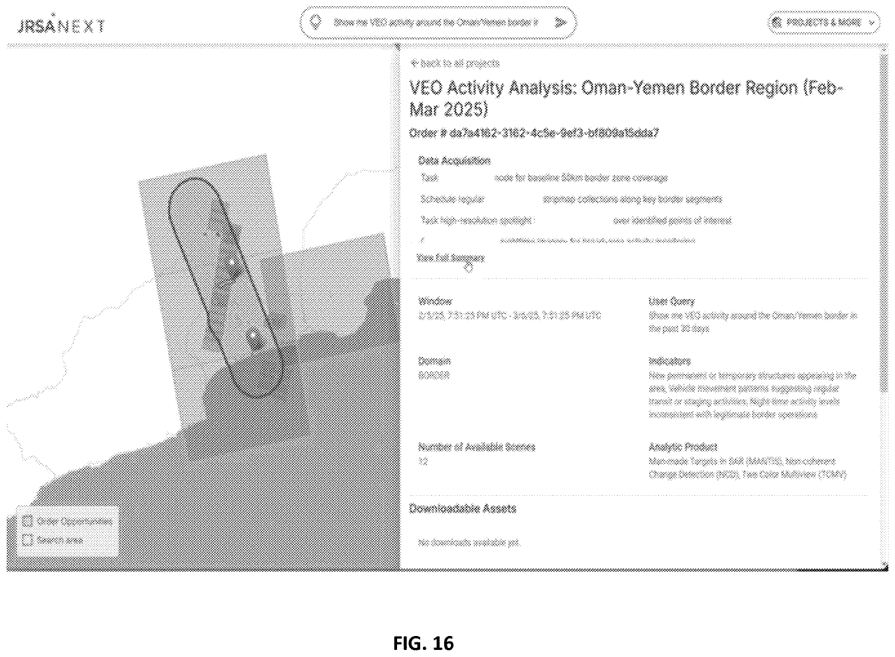

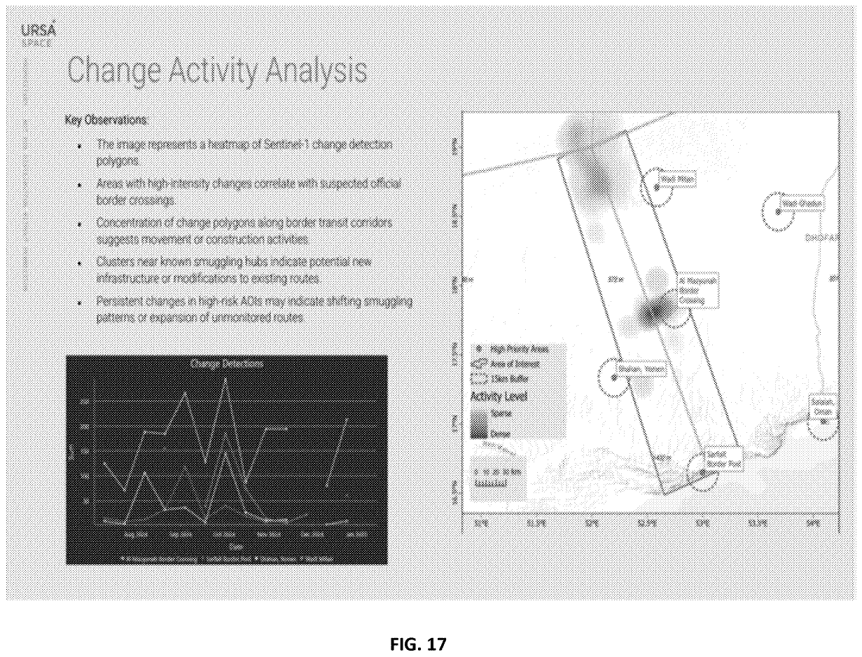

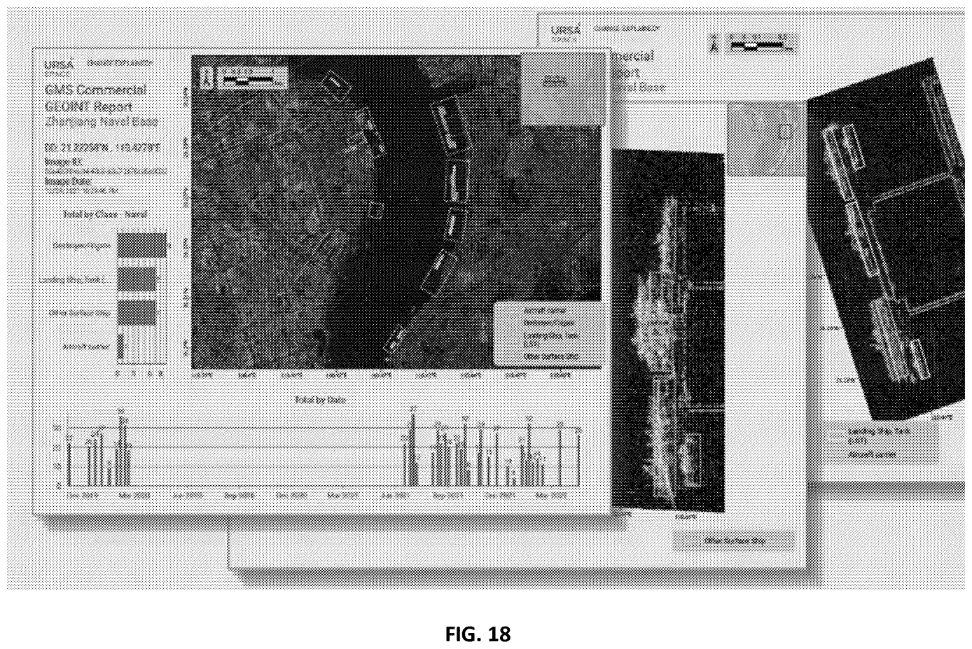

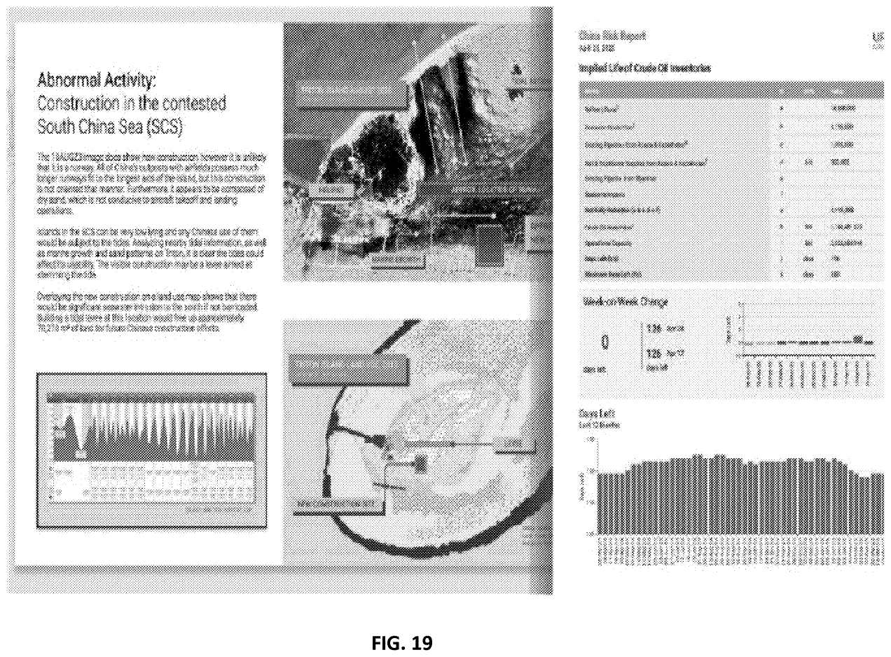

The report may include classification results, object detection data, visual overlays, or statistical reports. In some embodiments, the system may generate a quick initial answer to the requesters query (for example within 15 minutes) based on initial analysis and follow up later with a more complete report based on the final analysis. FIG. 16 shows an example of such an initial analysis for activity on the Oman-Yemen border. The system may later generate a more detailed report based on the completed analysis. The system may base the format of the report on the query to be answered and requester preferences. For example, FIG. 17 shows an example change activity analysis component based on the complete analysis. In another example, FIG. 18 shows tactical reports of detected activity with complete data provenance based on the completed analysis. In another example, FIG. 19 shows operational reports for deeper analysis and insight based on the completed analysis. In some embodiments, the system 100 allows data and results to be ported directly into other analysis software to customize analysis and visualization.

Visualization tools may be used to generate visual representations of the detected objects and areas of interest, overlaid on base maps or other contextual imagery. For instance, if SAR imagery analysis identifies damaged infrastructure, the output may present the detected locations superimposed on regional maps with flags or markers to indicate severity. Other outputs may highlight patterns, such as vehicles detected along a transit route, which could include object trajectories or location clustering maps. Results may be transmitted through communication pathways appropriate for the access level of the requester and sensitivity of the data. For example, FIG. 15 shows examples of an interactive dashboard allowing requester 105 to visualize detected objects on the map.

FIG. 5 is a flowchart of an illustrative method 500 for generating situational awareness through obtaining and analyzing geospatial data, in accordance with some embodiments of the technology described herein. In block 510, system 100 may the system 100 may determine there is an information gap. The system 100 may make the determination based on criteria and/or operations for data analysis set forth in the playbook. For example, the playbook may set out a sufficiency threshold for an analysis. The system may determine that there is an information gap between the collected data and the data to respond to the query within a set sufficiency threshold.

For example, based on the analysis results, the system may evaluate whether the data acquired and analyzed sufficiently fulfills the requester's objectives. If discrepancies, uncertainties, or inadequacies are detected-such as missing data for specific areas of interest, low-confidence object classifications, or limited contextual information, the system may identify these issues and flag them for the analyst or requester or may trigger a refinement workflow. The analysis agent may submit the refinement proposal to the requester 105 and/or analyst 190 including the recommended adjustments to imaging parameters, estimated costs associated with refined data collection, and anticipated benefits in improving subsequent analysis results. For instance, if a detected gap in object classifications spans a large geographic area, the system may provide cost-benefit calculations for deploying third-party satellites with higher-resolution capabilities to target these regions versus relying on lower-cost company-owned assets.

Further embodiments of block 510 are set forth in blocks 460, 630, 850, 2050, and 2060 described herein.

In block 520, the system 100 may identify supplemental data is available to address the information gap. Such supplemental data may be available in free data bases, in paid data sets, or able to be collected by scheduling data collection operations on equipment (e.g., scheduling the collection of satellite data.)

The system 100 may refine data collection based on recommendations generated in prior steps. These updates may include altering imaging specifications, adjusting spatial or temporal coverage, selecting alternative equipment (e.g., SAR satellites versus optical sensors), or utilizing a broader range of datasets from third-party repositories. For example, the system may modify collection instructions such as specifying new geospatial regions for overhead imagery, increasing image resolution to better classify detected objects, or scheduling targeted imaging during optimal time windows (e.g., daylight hours or periods of low atmospheric interference.)

In block 530, the system 100 may determine what supplemental data to collect. The system 100 may select the data from the candidate data based on factors such as availability, cost, and compatibility (for example in format or resolution) with the analysis. The system 100 may, for example, determine what the least expensive way to collect enough data of the correct type to pass the sufficiency threshold. The system 100 may provide the requestor with a proposal of supplemental data to collect, or possible sets of supplemental data options with information regarding the likely effect of the supplemental data on the analysis, for example, the increase in confidence interval, and the cost of the supplemental data collection. The requestor may then determine what supplemental data to collect.

In block 540, the system 100 may obtain the selected supplemental data. For instance, the system 100 may utilize the techniques described in step 820 to collect the data from various sources and clean and combine the data. The system 100 may interface with a plurality of data sources with the candidate data satisfying the data requirements The system 100 may compile the supplemental data with the original data.

In block 550, the system 100 may analyze the supplemental data with the original data. In some examples, prior to analysis, the system 100 may deduplicate portions of the collected data and supplemental data that are duplicative. For example, the supplemental data may pull in data tables with entries which overlap with entries in the early collected data sets. In order to not overweight the values, the system 100 may detect these duplicates and remove them prior to analysis. Analysis may proceed using any of the techniques described herein.

In block 560, the system 100 may generate an output a report. This generation may be according to any of the techniques described herein.

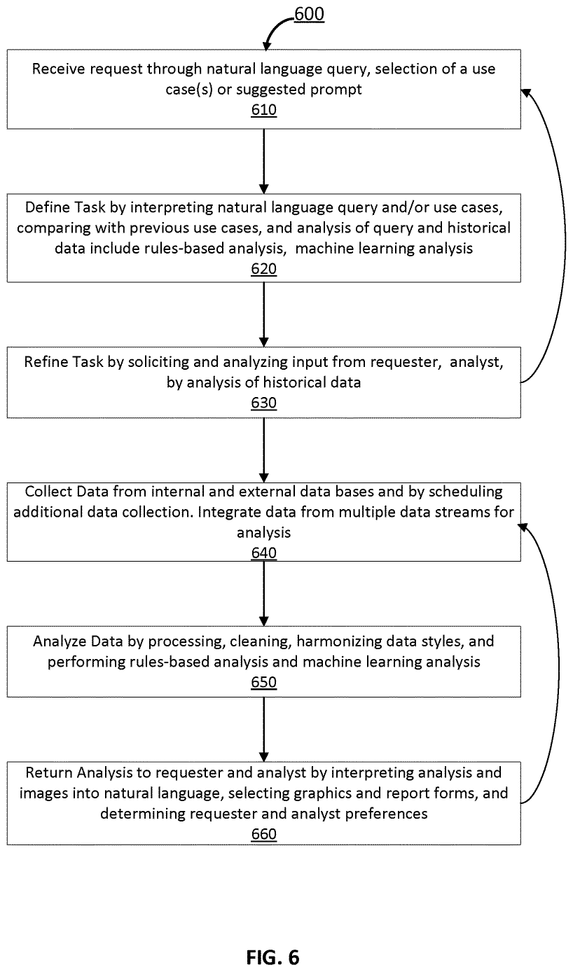

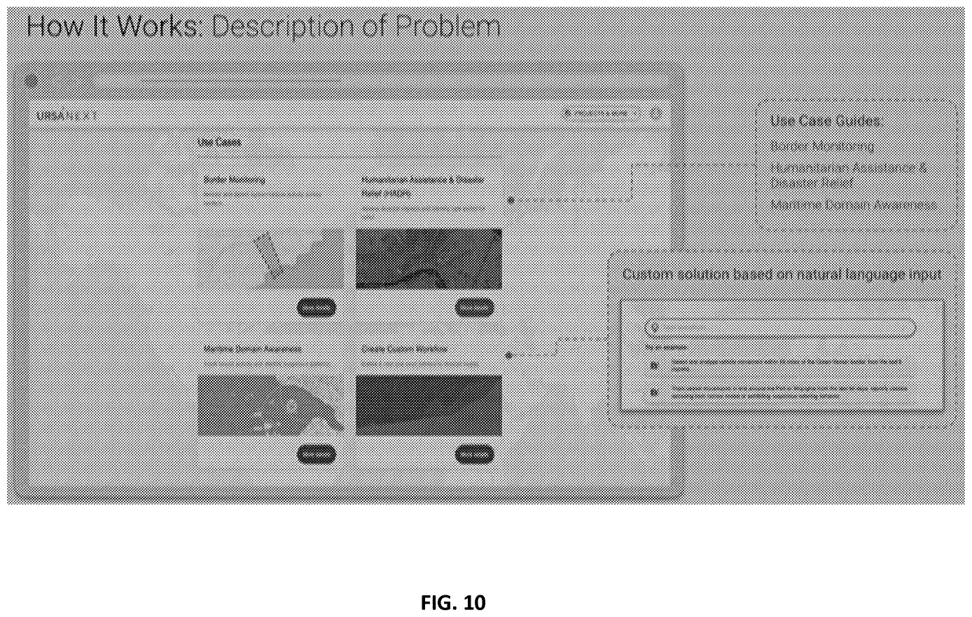

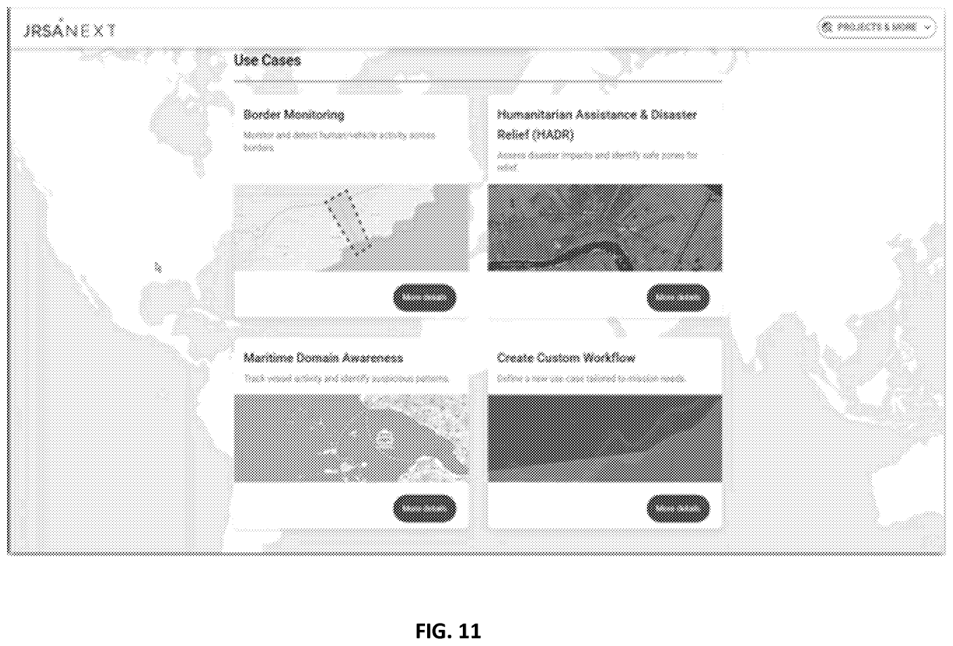

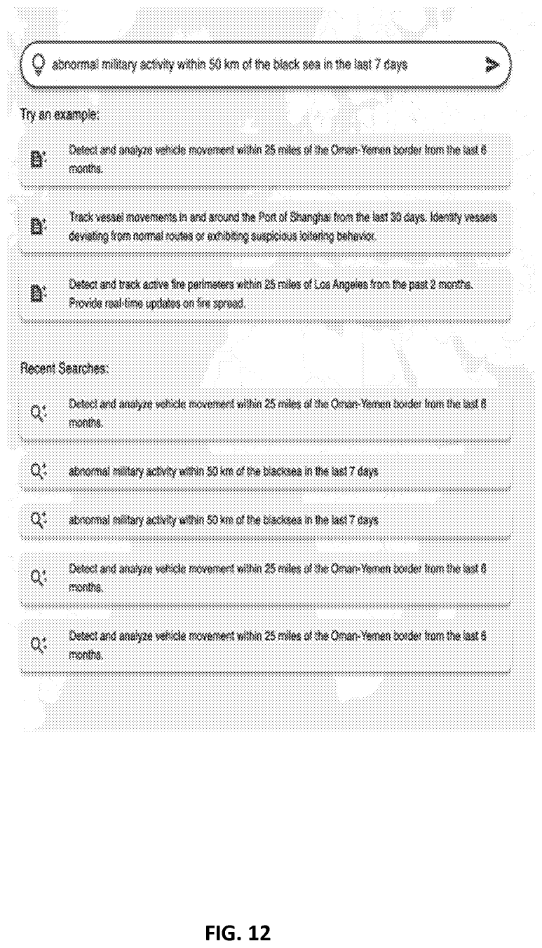

FIG. 6 is a flowchart of an illustrative method 500 for generating situational awareness through obtaining and analyzing geospatial data, in accordance with some embodiments of the technology described herein. In block 610, system 100 may receive a query from a requester 105 via requester device 110. The requester 105 may be an individual user, an automated program, or any other device capable of initiating and transmitting a request for data collection, processing, or related operations. The requester 105 may interface with a requester device facility 115 through a frontend graphical user interface, such as the interfaces shown in FIG. 10. In some instances, the requester 105 may select a suggested use case, such as those shown in FIG. 11. In other instances, the requester 105 may enter a natural language query into the interface such as the one depicted in FIG. 12 or model a query off of a suggested query as shown in FIG. 12.

In some embodiments, the requester may be an automated program and the system 100 may facilitate machine-to-machine communications via standard communication protocols, such as REST, GraphQL APIs, or other interprocess communication methods. The automated program may utilize preconfigured instructions to dispatch requests to the geospatial system 100, specifying parameters such as collection scope, filters, timing constraints, and intended use cases. Upon receiving a request, system 100 may process the communication, validate the request structure and authenticate the requester 105 based on identification credentials, tokens, or encrypted communication headers.

In some embodiments, the requester 105 may input various types of natural language requests into the geospatial system 100. These requests may include queries for real-time environmental data, such as temperature, humidity, or air quality metrics, captured by overhead sensors. The request may be a specific question, such as “how many ships are currently in the south sea?” or “how has the number of ships in the south sea trended based on time of day, month and year?” The requests may be comparative to a baseline, such as “have there been any unusual patterns in fishing vessel activity near section Thomas Shoal over the past month?” These requests may include more complex and predictive questions, such as “predict the economic activity level of the Boston port over the next year” or “monitor and predict the route of the Los Angeles forest fire.”

In some embodiments, the requester 105 may specify parameters for data aggregation, filtering, or analysis, such as setting thresholds for alerts, or generating or uploading predictive models based on historical data trends. In some embodiments, the requester 105 may rank the importance of certain parameters, such as speed of receiving analysis, overall cost of analysis, or accuracy of results.

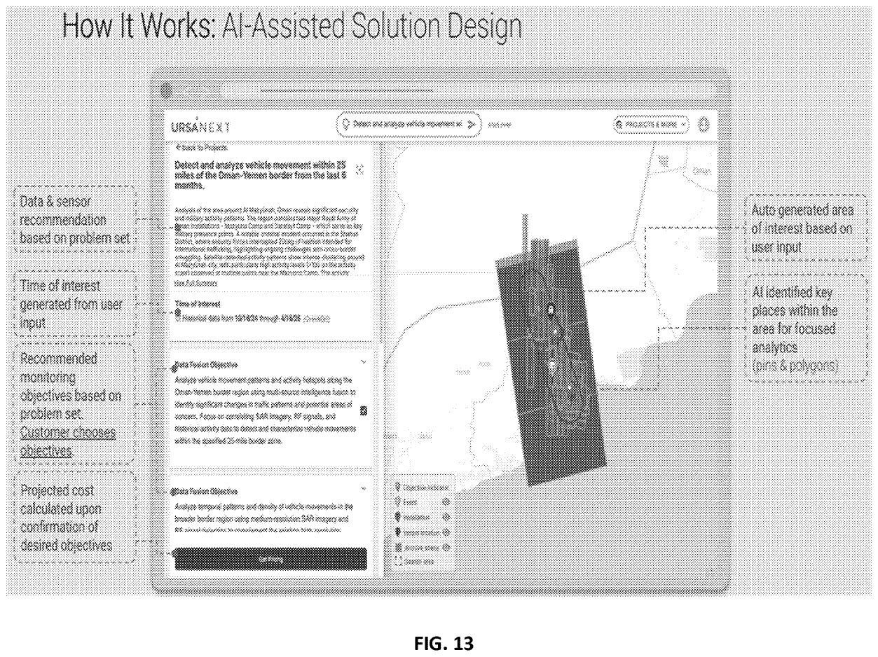

In block 620, system 100 defines the task. The tasking agent 125 can interpret the request, for instance by performing natural language processing or comparing it with a known database of previous prompts. The tasking agent 125 may analyze the request, such as by breaking it up into the goal (or “mission”), the geographic area of interest, and the time of interest. These may be displayed on the graphical user interface of requester device facility 115 as depicted in FIG. 13. The tasking agent may utilize a rules-based approach or access historical data to define the tasks it recommends in order to answer the query. An example of a set of generated tasks is displayed on the UI depicted in FIG. 15.

In optional block 630, the system 100 refines the task. In some embodiments, the tasking agent 125 will refine the data collection and analysis methodology (the “task”) based on previous data collected and stored in data storage unit 135. In some embodiments the tasking agent 125 may return a proposed data collection and analysis methodology to one or more of the requester 105 and analyst 190 for input.

For example, as depicted in FIG. 13, system 100 may present to the requester an analysis and data fusion objective and may return the time of interest. The GUI may display data and sensor recommendation based on the problem set. The system 100 may display to the requester the time of interest generated from the requester input. The system 100 may display recommended monitoring objectives based on the problem set and solicit feedback from the requester to select the objectives from the list or input alternate objectives. The system 100 may have generated the cost based on the selected objectives.

In block 640, system 100 collects data. System 100 may utilize the data collection methodology set out by the tasking agent 125 (as may have been adapted by the requester 105 and/or analyst 190) to collect the data. In some embodiments, the tasking agent 125 may query the data storage unit 135 to collect data housed in the data storage unit 135 and interface with third-party platforms to secure access to data in third-party platforms 160. In some cases, the tasking agent 125 may also submit tasks to overhead data collection devices 170 directly through communication device 175 of via a third-party platform 150.

In block 650, system 250 analyzes the data. Analytics agent 130 may analyze the data based on the methodology set out by the tasking agent 124 (as may have been adapted by the requester 105 and/or analyst 190). The analytics agent 130 may compile, clean, and otherwise process the data and perform analysis based on the rules-based agent and/or machine learning agent. In some embodiments, if, during the course of analysis, the analytics agent 130 determines that integral data is missing, it may refer to the tasking agent 124 to collect more data and/or may flag this for the requester 105 and/or analyst. In some embodiments, once the analytics agent 130 completes analysis, it sends the response to analyst 190 to review, refine, and signoff on the analysis, ensuring a human in the loop.

In block 660, system 100 returns the analysis to the requester. In some embodiments, the system returns a confidential interval and suggests next steps. At this stage, the requester 105 can accept the analysis, request additional analysis, request further data collection and analysis, or submit a new query.

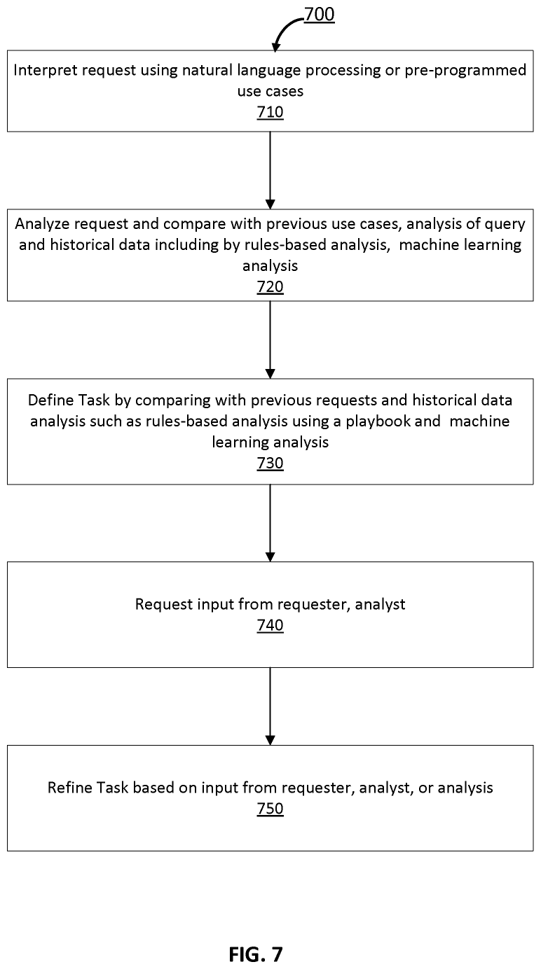

FIG. 7 is a flowchart of an illustrative method 700 for generating situational awareness through obtaining and analyzing geospatial data, in accordance with some embodiments of the technology described herein. FIG. 7 depicts one embodiment of a method 700 to define the task, such in block 620 of method 600. System 100 interprets the request at block 710 and analyzes the request at block 720. The system defines the task at block 730, and optionally, requests input from the requester 105 and/or agent 190 at block 740. Based at least in part on the input, the system 100 refines the task at block 750.

At block 710, the tasking agent 125 may interpret the query. In some embodiments, the tasking agent 125 may utilize natural language processing techniques in conjunction with historical data to interpret the query. The tasking agent 125 may receive the request in the form of unstructured natural language text, such as depicted in FIG. 12 and may parse the request to identify key linguistic elements, such as entities, intents, and contextual modifiers, using an NLP model trained on a corpus of geospatial and linguistic data. The tasking agent may extract geospatial references from the parsed text, including but not limited to place names, coordinates, and landmark descriptions. In some embodiments, the tasking agent may utilize retrieval-augmented generation (“RAG”) to interpret the query. In some embodiments, the tasking agent may use third-party software such as Open AI, Llama, Grok, Claude, Gemini or others to interpret the query.

In some embodiments, the tasking agent may utilize an algorithm to map references to geographic coordinates or regions. The system may incorporate disambiguation strategies to resolve ambiguities in the request, such as distinguishing between multiple locations with identical or similar names by analyzing additional contextual clues within the request, such as temporal references, proximity constraints, or requester-specific preferences.

In some embodiments, the tasking agent may decompose the input prompt into a goal (or “mission”), geographic location, and time of interest. The tasking agent may be trained to determine the location based on the context of the prompt despite colloquialism and may determine the range of the area of interest either by being directly told in the prompt or by assessing the mission. For instance, if the request is secure an overhead image of the White House, the tasking agent may assess area of interest is relatively small and in the center of Washington DC. If, in contrast, the request is to monitor a forest fire in Los Angeles, the tasking agent may assess that the area of interest is relatively large, and that imaging should extend outside of Los Angeles proper as far as the fire extends. If the task manager is uncertain of the request and the range, the task manager may query the requester to confirm that it has understood the proper geographic location, range of interest, mission, and time.

In block 720, system 100 may analyze the requests. (In some embodiments, block 310 interpretation and block 320 analysis occur concurrently or as a single block.) In some embodiments, the system 100 may analyze the request to determine the mission by utilizing the area of interest and time of interest determined above. The tasking agent may utilize retrieval-augmented generation (“RAG”) to determine the mission.

In some embodiments the system maintains a request-history library, implemented, for example, within data storage unit 135, in which every previously received request record is stored with metadata (time stamp, requester identifier, request parameters, and outcome codes) and the subsequent data collection and analysis. The tasking agent may utilize RAG and semantic similarity matching to the library of past queries to analyze the request. In some embodiments, the tasking agent may use third-party software such as Open AI, Llama, Grok, Claude, Gemini or others. The tasking agent may determine a confidence interval for the best match mission. If the confidence interval is below a set threshold, the system 100 may abort the sequence and return an error or may flag for analyst 190 or requester 105 review.

In some embodiments, each query may be passed through a feature-extraction pipeline to generate a feature vector. The vector may be stored alongside the raw request in an indexable structure. To accelerate look-ups, the library may include one or more similarity search structures such as metric-tree indices (e.g., KD-trees, ball trees, or vantage-point trees), approximate nearest-neighbor graphs (e.g., HNSW), or locality-sensitive hashing. Upon receiving a new request, the tasking agent may determine a query vector using the feature extraction pipeline, then executes a nearest neighbor search against the indexed repository. The engine may return the closest task, which may be the historical request query whose stored vector exhibits the minimum distance along with a ranked list of K-nearest neighbors. A similarity score may be derived which may be used by the tasking agent to determine whether to flag or abort the query. In some embodiments the comparison workflow retrieval augmented generation (RAG) to refine task matching. After the system has determined the top-K candidate requests, the tasking agent may use RAG to combine the textual or structured content of the new request, and condensed “context snippets” extracted from each candidate request, into a prompt passed to a large-language model which may generate a semantic similarity score. The system may further determine a confidence metric with respect to the semantic similarity score.

In block 730, system 100 may define the task. In some embodiments, the task manager may leverage previously completed tasks and apply a rules-based engine and/or machine learning techniques to determine a task list. As explained above, the task manager may determine the closest previous request. System 100 may store a vector database of past missions with corresponding playbooks, such as data storage unit 135. Once the closest previous request is determined, the task manager may fetch the playbook associated with that previous request in the vector database. The task manager may query the playbook to determine the tasks, data collection methodology, and data assessment associated with the historic query. In some embodiments, the task may include a set of tasks for analysts as depicted in FIG. 15 which may be performed by the analytics agent or the analyst 190. In some embodiments, the tasks for analysts may be presented to the requester 105 on the GUI of the requester facility 115, such as in a list as depicted in FIG. 15.

In some embodiments, playbooks may be added or updated to system 100 to add functionality and allow other applications and answer new requests. The playbook may be used based on situational indicators. To add a playbook, the system 100 may be trained to understand what data and analytic analysis are required for an indicator. The system 100 may determine that a new request is for a new indicator that it is not able to match with a playbook. Playbooks for new indicators may be added to system 100 by utilizing one or more: (1) playbooks for similar requests, (2) analyst or other human input, or (2) an external playbook submitted to the system 100. When a new indicator is presented to system 100, the system 100 may flag analyst 190 regarding the new indicator. The system 100 may in some cases additionally do one or more of (1) present analyst 190 with a proposed playbook (for instance, by using a playbook associated with a similar indicator or a playbook it was supplied by the requester or another party), (2) work with the analyst 190 to develop a playbook for the new indicator, or (3) request a playbook from a requester 105, analyst 190, or other source. Once a new playbook has been approved, for instance by the analyst 190 or requester 105, it may be added to data storage unit 135 and associated with the new indicator.

In some embodiments, the system may incorporate a machine learning model trained on historical task data which may be used to augment the tasks from the playbook. For instance, the system may determine that a greater quantity of data would be beneficial to increase statistical confidence of the data analysis, or may suggest utilizing specific databases which historically have been more quickly accessible based on urgency of the query. In another example, the system may suggest certain initial reporting formatting or analysis styles and cost/confidence ratio due to previous requester preferences. Additionally, system 100 may suggest methods of optimizing the data collection and analysis. The system may query the historical data including the task descriptions, completion times, priorities, and contextual factors. By analyzing this data, the system 100 may identify patterns and dependencies among tasks, enabling it to predict and recommend an optimized sequence of tasks for future workflows. The model may refine its predictions based on user feedback and newly completed tasks, increasing efficiency and performance.

In some embodiments, the tasking agent may begin fetching pre-solution data which may be provided to the RAG module or machine module to improve predictions. The tasking agent may fetch internal data (such as the Ursa Space data lake) or data from free databases (such as the Jane database.) The tasking agent may provide this initial data to the requester 105 along with the recommended task list.

In some embodiments, in block 740, system 100 may request input from the requester 105. The system may provide the requester with a generated task list such as the one in FIG. 15, optionally accompanied by supporting data, proposals, or analytical insights. In some embodiments, the system may provide instructions from the playbook, the pre-fetch information, and recommendations on tasking and downstream processing. For example, FIG. 15 displays a GUI interface showing recommended tasks for analysts based on the requester's query. In some embodiments, the system may provide the requester with a list of data sources it recommends utilizing (and may optionally display the data associated with the data source.) For example, FIG. 14 shows recommended data sources to utilize for the requester's query.

System 100 may price additional data collection and analysis, and optionally, provide levels of price and statistical certainty, additional data acquisition, and analysis. Task lists are presented through a user interface and may include parameters such as estimated task completion time, projected resource usage, and cost analysis, allowing the requester to assess trade-offs between multiple proposed options. The user interface may additionally provide task dependencies, risk profiles, or expected outputs for each recommended task.

In some embodiments, system 100 may analyze historical data to improve analysis or customize recommendations, for instance, based on the identity and history of the requester. System 100 may suggest integrating data from various sources, with the databases selected depending on factors such as the access of the requester and on the domain of the use case. These sources may include government and industry databases, public or private APIs, sensor networks, or advanced data collection platforms such as satellite-based imaging systems or aerial drones. For instance, in the context of agricultural planning, the system might recommend accessing satellite imagery for real-time crop monitoring and combine it with non-aerial data such as soil moisture data derived from IoT devices deployed in the field. Similarly, in urban infrastructure planning, aerial data may be augmented by LiDAR data.

In some embodiments, system 100 may provide a breakdown of costs, benefits, and constraints associated with accessing and incorporating additional datasets or conducting additional or advanced analyses. System 100 may pair its recommendation with metrics, such as estimated cost and latency for data retrieval or collection, computational requirements for integrating the data, and the potential impact of incorporating the data on task list accuracy or execution feasibility. For example, if the requester selects high-resolution geospatial data collected via satellite from a specific location, the system 100 quantifies the monetary cost of commissioning image capture, determines when the device 170 is accessible for commissioning and associated time lag, quantifies the storage and processing requirements, and calculates the increase in cost, time delay, and precision compared to using publicly available datasets.

In block 750, system 100 refines the task. In some embodiments, the system 100 may provide feedback mechanisms and alters the task lists based on requester-specific priorities or constraints. In some embodiments, feedback may be provided via direct interaction with the graphical user interface and may include explicit modifications to proposed tasks, alterations to constraints, new priorities, or acceptance/rejection of suggested auxiliary data sources. Upon receiving feedback, system 100 may perform recalibration to adjusts its algorithms, update cost analysis models, and refine proposed task sequences.

The system may use feedback to recalibrate task parameters such as priority, dependencies, resource requirements, and timeline predictions. For instance, if the requester prioritizes certain tasks over others or selects a preferred dataset for analysis (e.g., satellite imagery or particular databases), the system may adjust its rankings and predictive algorithms accordingly. In some embodiments, the system may utilize this feedback to update its predictive module. For instance, system 100 may utilize feedback to updates to algorithmic weights, priority scores, or dependency mapping which may be preferentially utilized for a particular requester or generalized across a task to better match requester preferences and operational goals.

In some embodiments, the system may expand the scope or granularity of analytical insights based on the requester's feedback. For example, if the requester opts for additional data sources (e.g., meteorological databases or satellite imagery), the system may recalculate resource usage projections and cost breakdowns for tasks influenced by the newly incorporated data. Additionally, the system may perform comparative analyses across datasets to highlight potential benefits or risks associated with the selected input sources, such as increased accuracy in outcome prediction versus additional monetary or computational costs.

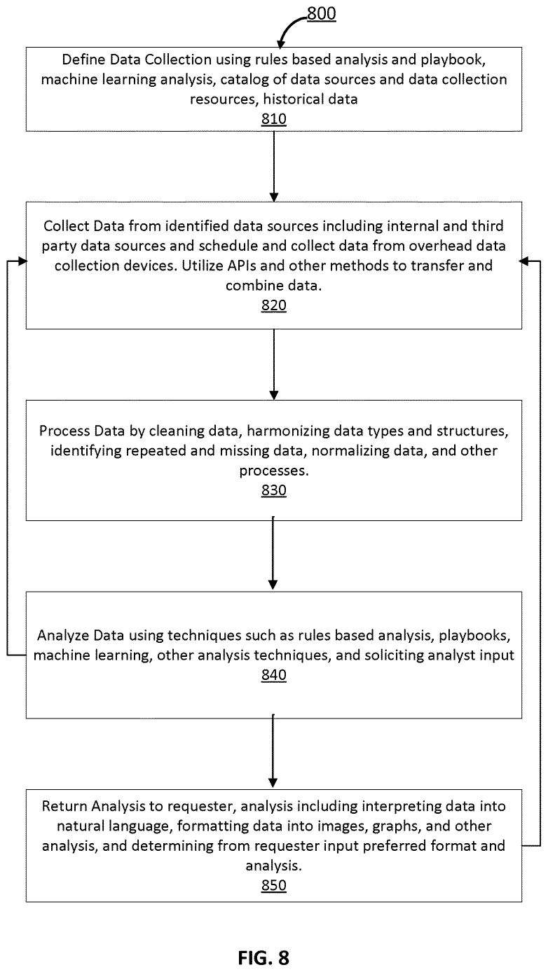

The system may organize tasks and data analysis outputs into categories such as high-priority tasks, time-sensitive dependencies, or tasks that yield significant cost benefits based on previous and newly integrated data sources. Supporting insights, such as detailed cost analysis, efficiency projections, and task interdependencies, may be displayed alongside the updated task list to facilitate decision-making. Optionally, the system may offer visualized comparisons between the prior task list and the updated version highlighting areas where changes have been made in response to requester input. FIG. 8 depicts a method 800 to perform data collection and analysis, such in blocks 640-660 of method 600 according to some embodiments. In some embodiments the method may include defining the data collection at block 410. In other embodiments this block may be part of method 700. In block 820, system 100 may collect the data and may process the data in block 830. System 100 may analyze the data at block 840 and return the analysis at block 850.

In block 810, system 100 may define the data to be collected. System 100 may determine the data collection methodology based on the playbook and/or approved by the requester 105 as described herein. In some embodiments, system 100 may generate a data acquisition definition to specify the information to be collected. The definition may include a semantic description of the task goal (e.g., vehicle count along route R between 07:00-09:00 EDT on 12 May 2025); quality of service attributes (refresh rate, geospatial resolution, spectral bands, confidence level); and cost and access constraints (maximum spend, subscription tier, government classification, etc.).

System 100 may compile a catalog of potential data sources and attributes such as cost. System 100 may, for instance, assign zero marginal cost for internal repositories. In contrast, third party commercial databases may be annotated with pricing models (e.g. per-API call, or per-gigabyte) as well as latency and reliability statistics. On-demand overhead devices 170 (e.g., electro-optical or SAR satellites) may be annotated with predictive availability windows, angle limitations, and cost. Additionally, the entries may store data around latency and access, such as which requester types may access the data.

In some embodiments, the system may select the data sources based at least in part on rules, such as those from the playbook, and/or a reinforcement learning agent trained on historical fulfillment outcomes. The rules may set constraints, such as always satisfy a minimum confidence interval of at least 95% for certain application, while the learning agent may select data based on a weighted value of the predicted contribution of the source, the monetary or opportunity cost, and an accuracy metric. The agent may be tuned using weights derived from the requester's preferences.

For on-demand data collection, such as for collection of additional satellite data, the system 100 may generate a collection request plan specifying factors such as sensor, time slot, geometry, and downlink channel. For instance, in the case of satellites, the system may compare competing satellite operators, factoring in cost and latency. If the projected cost exceeds the requester's limit, the engine may explore cheaper alternatives (e.g., coarser spatial resolution or older imagery) and resubmit an alternate plan to the requester or notify the requester that the task cannot be completed under the current cost parameters.

In block 820 the system collects and combines the data. The system may query internal data repositories which may index based on factors such as geolocation, resolution, and time. In some embodiments, the system may access third-party databases via API integrations, enabling automated querying, retrieval, and delivery of data. They system may generate API requests based on the requester's task description. After querying the external database, system 100 may process the data to ensure relevance and usability.

In some embodiments, when existing data sources (internal or third-party) do not contain the necessary data, the system can initiate new data collection through device 170. In some embodiments, the tasking agent 125 may query the device owner to identify device availability. Using prediction models, the system may estimate the success probability of a task, time constraints, and cost. For example, if the requester specifies high-resolution optical imagery of a particular region, the system may evaluate multiple options by comparing orbital path predictions, response latency, and coverage suitability. Once the device 170 has been selected, the system may establish communication with one or more of the device 170, the communication device 175, and the third-party platform 150 to retrieve the data after collection.

At block 830, the system 100 may process the data. In some embodiments, newly collected data may be optimized through processing techniques, such as filtering and cleaning. Data retrieved internally or from third-party databases may be processed prior to analysis. System 100 may clean, transform, normalize and organize the incoming data to ensure it is in a consistent format and suitable for further analysis. The analytics data may remove noise, address missing, low quality, duplicate, or corrupt data, and extract relevant features from unstructured data. In some embodiments, the analytics agent may utilize algorithms to fuse multi-modal data (e.g., combining SAR with optical or hyperspectral imagery) to enhance analysis.

In block 840, system 100 may analyze the data. In some embodiments, the analytics agent may utilize rule-based processing, machine learning analysis, or both. The rule-based processing may use a predefined set of conditions, heuristics, and deterministic models tailored to the specific analytical tasks. These rules may filter, classify, and prioritize data based on known patterns or conditions. For instance, the rule-based engine might apply conditional logic to identify anomalies in time-series data or to segment areas of interest within satellite images. This rule-based process may be set out in the playbook selected during task definition.

In some embodiments, the analytics agent may additionally or alternately utilize a machine learning engine to uncover patterns and generate predictive insights. The machine learning engine may employ supervised learning models for tasks such as regression or classification, unsupervised learning models for clustering or anomaly detection, and neural networks for tasks like image recognition. These models may be trained on relevant datasets and adapted through retraining. In some instances, the selection of the appropriate machine learning engine may be set out in the playbook selected during task definition. In some instances, the machine learning insights may be utilized by an analyst 190 or other party to update a playbook or generate a new playbook to a new query without a playbook.

In some embodiments, the analytics engine 130 may use object classification techniques to identify, categorize, and extract the relevant features from datasets. The classifiers may use machine learning models, such as Convolutional Neural Networks (CNNs), Decision Trees and Support Vector Machines (SVMs) to distinguish between various types of objects, patterns, or anomalies present in overhead imagery and related datasets. For instance, object classification algorithms trained on overhead imagery datasets may be used to identify features like buildings, roads, vehicles, vegetation, water bodies, or specific objects of interest. For example, the classifier can identify vehicles on highways for traffic management or detect changes in construction progress for project monitoring. In some embodiments, the analytics agent 130 may optimize the object classification model based on parameters associated with the collected imagery. These parameters may include image resolution, spectral band configuration, atmospheric conditions, and geographic region. In some embodiments, object classification may involve combining machine learning models with rule-based classifiers based on the task parameters. For example, in disaster response scenarios, rules may prioritize the identification of damaged infrastructure over intact structures.

In some embodiments, once the initial object classification is performed, the analytics agent may review the analysis to assess the accuracy, relevance, and reliability of the classified objects. Confidence scores may be assigned to each classified object based on the probability that the classification is correct. Objects that fall below a predetermined confidence threshold may be flagged for reclassification using alternate techniques analyst 190 review, or additional training datasets. In some cases, the classified data may be validated through statistical and contextual analysis by comparing the extracted features with known benchmarks or reference datasets. For example, if the object classifier is identifying urban structures from satellite images, the system may cross-check the location, geometry, and layout of these structures against maps and urban planning databases.

In some embodiments, the analysis and results may be reviewed internally by analyst 190 prior to completion. The analyst 190 may perform quality check and additional analysis and interpret ambiguous elements. For instance, the analyst may inspect low-confidence classifications flagged by the system to verify object detection results and include commentary or suggested next steps in the final report.

In some embodiments, based on the analysis results, the system may evaluate whether the data acquired and analyzed sufficiently fulfills the requester's objectives. If discrepancies, uncertainties, or inadequacies are detected-such as missing data for specific areas of interest, low-confidence object classifications, or limited contextual information, the system may identify these issues and flag them for the analyst or requester or may trigger a refinement workflow. The analysis agent may submit the refinement proposal to the requester 105 and/or analyst 190 including the recommended adjustments to imaging parameters, estimated costs associated with refined data collection, and anticipated benefits in improving subsequent analysis results. For instance, if a detected gap in object classifications spans a large geographic area, the system may provide cost-benefit calculations for deploying third-party satellites with higher-resolution capabilities to target these regions versus relying on lower-cost company-owned assets.

In block 850, system 100 may return the analysis and propose data collection refinement. After analysis, system 100 may format the analysis in a report for delivery to the requester 105 or analyst 190 based on the request and preference of the requester 105. The report may include classification results, object detection data, visual overlays, or statistical reports. In some embodiments, the system may generate a quick initial answer to the requesters query (for example within 15 minutes) based on initial analysis and follow up later with a more complete report based on the final analysis. FIG. 16 shows an example of such an initial analysis for activity on the Oman-Yemen border. The system may later generate a more detailed report based on the completed analysis. The system may base the format of the report on the query to be answered and requester preferences. For example, FIG. 17 shows an example change activity analysis component based on the complete analysis. In another example, FIG. 18 shows tactical reports of detected activity with complete data provenance based on the completed analysis. In another example, FIG. 19 shows operational reports for deeper analysis and insight based on the completed analysis. In some embodiments, the system 100 allows data and results to be ported directly into other analysis software to customize analysis and visualization.

Visualization tools may be used to generate visual representations of the detected objects and areas of interest, overlaid on base maps or other contextual imagery. For instance, if SAR imagery analysis identifies damaged infrastructure, the output may present the detected locations superimposed on regional maps with flags or markers to indicate severity. Other outputs may highlight patterns, such as vehicles detected along a transit route, which could include object trajectories or location clustering maps. Results may be transmitted through communication pathways appropriate for the access level of the requester and sensitivity of the data. For example, FIG. 15 shows examples of an interactive dashboard allowing requester 105 to visualize detected objects on the map.

The system 100 may refine data collection based on recommendations generated in prior steps. These updates may include altering imaging specifications, adjusting spatial or temporal coverage, selecting alternative equipment (e.g., SAR satellites versus optical sensors), or utilizing a broader range of datasets from third-party repositories. For example, the system may modify collection instructions such as specifying new geospatial regions for overhead imagery, increasing image resolution to better classify detected objects, or scheduling targeted imaging during optimal time windows (e.g., daylight hours or periods of low atmospheric interference.)

In some embodiments, system 100 may break up the query into objectives, for instance based on the information, rules, or objectives set forth in the playbook best matched to the query. For instance, for monitoring violent extremist organizations (VEO), system 100 may break the query into a first objective, VEO activity monitoring; a second objective, VEO Communication Network Analysis; a third objective, VEO Logistics and Supply Routes; and a fourth objective, Human Terrain and Community Vulnerability. These objectives are exemplary only and depending on the query there may be greater or fewer objectives of a nature relevant to the query submitted by the requester 105.

For an exemplary query, the first objective may be VEO activity monitoring. The tasking agent may include a module that implements the structured data fusion objective generation. The data fusion module may include a parsing component which processes unstructured requester 105 text into structured query parameters. The data fusion module may include a location of interest component which determines relevant geographical points based on proximity and data activity. The data fusion module may include a validate objective component which generates computational consistency through schema validation.

For the exemplary query, the second objective may be VEO Communication Networks Analysis. The analytics agent may include a source integration module that implements the structured data fusion objective generation that manages information source integration for RF signal analysis. The source integration module may include an integration component which handles integration of specialized signal intelligence sources. The source integration module may include a movement correlation component which implements algorithms for relating electromagnetic signals to physical patterns and movements. The source integration module may include a compatibility component which ensures technical compatibility between requested information sources. The source integration module may include an overlay visualization component which creates visualization specifications for a signal overlay map output.

For the exemplary query, the third objective may be VEO Logistics and Supply Routes. The analytics agent may include a logistics analysis module that provides core solution architecture for logistics analysis. The logistics analysis module may include a SAR component which implements specialized algorithms for SAR imagery analysis and change detection. The logistics analysis module may include a transport activity component correlates and maps terrain disturbances to potential transportation activity. The logistics analysis module may include a supply detection component which identifies potential supply lines through computational pattern analysis. The logistics analysis module may include a movement corridor component which implements detection algorithms for movement pattern identification.

For the exemplary query, the fourth objective may be Human Terrain and Community Vulnerability. The analytics agent may include a vulnerability module that implements analysis around terrain and community vulnerability. The vulnerability module may include a population distribution component which implements computational methods for demographic data analysis. The vulnerability module may include a settlement activity component which maps connections between population centers and VEO presence. The vulnerability module may include an infrastructure component which processes infrastructure data to identify community characteristics. The vulnerability module may include a vulnerability metric component which implements quantitative algorithms for vulnerability assessment.

In addition to the objective modules, in some embodiments, the system 100 may include an Executive Intelligence Brief module (the “EIB module”) which implements narrative synthesis from geospatial data. The EIB module may include a geographic narrative component which transforms technical geographic data into structured text. The EIB module may include an identify cross-dataset patterns component which implements computational methods for finding significant relationships across data sources. The EIB module may include generate coordinate references module which creates evidence-backed geographic references. The EIB module may include a structure intelligence narrative module which implements formal narrative structure with defined transitions.

Additionally, in some embodiments, system 100 may include additional modules for supporting implementation. For instance, these modules may support the objectives by defining visualization specifications, implementing the technical rendering requirements for visualization types, and provides validation for visualization parameters. For example, there may be a solution router module which may handle the API routing for all solution components, connects the framework (such as an opensource frame work like python DSPy) to the implementation logic, and manage request/response handling for the prompt system. In another example, there may be a decomposition module which defines schema models for the decomposition process, implements validation across prompts, and ensures type consistency across the system. In a further example, there may be a geoint decomposition module which provides the LLM integration layer, contains code for prompt construction and templating, and implements the interface between the framework and the prompt system.

In the above example, system 100 addresses several significant technical challenges in geospatial intelligence analysis. Electromagnetic Spectrum Analysis was addressed through computational methods that correlate RF signal data with physical movement patterns to identify command structures. Supply Route Detection was addressed through SAR change detection algorithms that identify unpaved routes by correlating terrain changes with transportation patterns. Community Vulnerability Assessment was addressed through technical integration of population distribution data with conflict events to identify at-risk settlements. Data Type Heterogeneity was addressed through computational methods for standardizing and correlating disparate data types from multiple intelligence sources.

The system 100 and methods disclosed herein incorporates multiple technical approaches. Included is a computational approach that defines explicit input/output contracts for diverse data formats (SAR imagery, RF signals, population data) with standardized conversion and correlation methods. Additionally, included is a step-by-step processing pipeline, computational validation at each stage, and technical consistency across modules. Additionally, it leverages a technical approach to schema validation, implements computational validation of field types, and provides robust error handling. Additionally, it leverages methods for data type converting, implementing computational validation of type correctness, and ensuring schema compatibility across modules. It also includes technical methods for translating complex geographic features into structured narrative intelligence reports while maintaining coordinate reference and evidence backing.

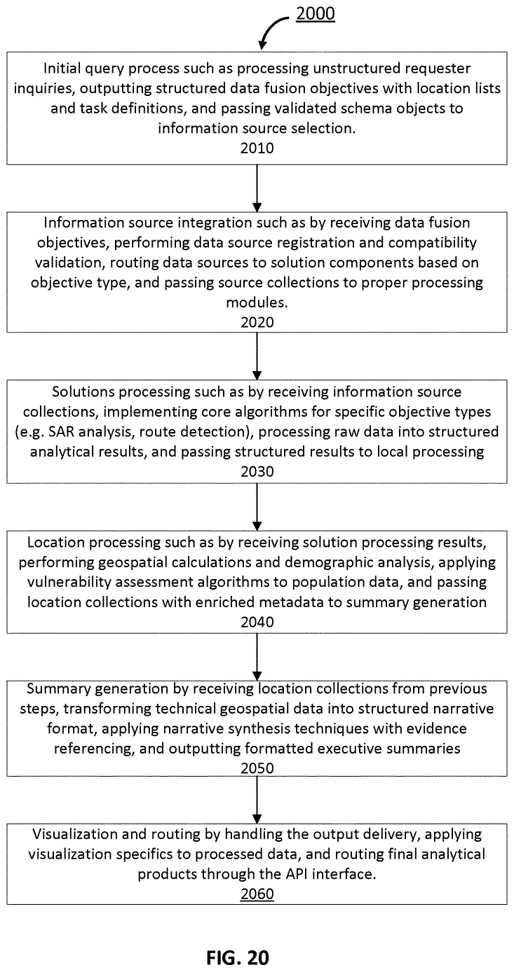

FIG. 20 depicts an exemplary method data flow pipeline between exemplary components according to some embodiments. In block 2010, initial query processing module processes unstructured inquiries from requester 105, outputs structured data fusion objectives with location lists and task definitions and passes validated schema objects to information source selection. In block 2020, information source integration module receives data fusion objectives, performs data source registration and compatibility validation, routes appropriate data sources to solution components based on objective type and passes source collections to appropriate processing modules. In block 2030, the solution processing module receives information source collections, implements core algorithms for specific objective types (SAR analysis, route detection), processes raw data into structured analytical results and passes structured results to location processing. In block 2040, the location processing module receives solution processing results, performs geospatial calculations and demographic analysis, applies vulnerability assessment algorithms to population data, and passes location collections with enriched metadata to summary generation. In block 2050, the summary generation module receives location collections from previous stages, transforms technical geospatial data into structured narrative format, applies narrative synthesis techniques with evidence referencing and outputs formatted executive summaries with technical accuracy. In block 2060, the visualization and routing module handles output delivery such as applying visualization specifications to processed data and routing final analytical products through the API interface.

Techniques operating according to the principles described herein may be implemented in any suitable manner. Included in the discussion above are a series of flow charts showing the steps and acts of various processes for geospatial data collection and analysis. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit, Field Programmable Gate Array (FPGA), or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one of ordinary skill in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including application software, system software, firmware, middleware, embedded code, or any other suitable type of software. Such computer-executable instructions may be written using any of a number of suitable programming languages and/or programming or scripting tools and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application, for example as a software program application. In other implementations, the functional facilities may be adapted to interact with other functional facilities in such a way as from an operating system. In other words, in some implementations, the functional facilities may be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (i.e., as a single unit or separate units), or some of these functional facilities may not be implemented.

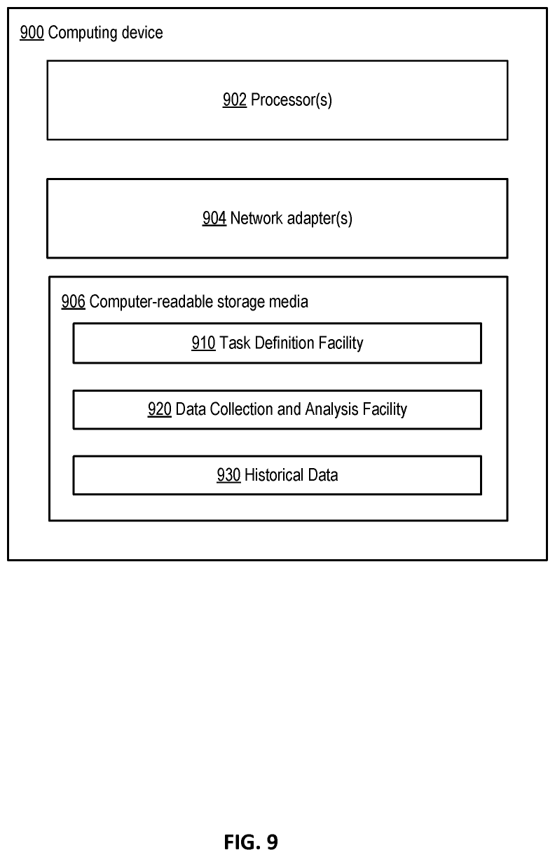

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), persistent or non-persistent solid-state memory (e.g., Flash memory, Magnetic RAM, etc.), or any other suitable storage media. Such a computer-readable medium may be implemented in any suitable manner, including as computer-readable storage medium 906 of FIG. 9 described below (i.e., as a portion of a computing device 900) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions, the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable system, including the exemplary system of FIG. 1, or one or more computing devices (or one or more processors of one or more computing devices) may be programmed to execute the computer-executable instructions. A computing device or processor may be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 9 illustrates one exemplary implementation of a computing device in the form of a computing device 900 that may be used in a system implementing the techniques described herein, although others are possible. It should be appreciated that FIG. 9 is intended neither to be a depiction of necessary components for a computing device to operate in accordance with the principles described herein, nor a comprehensive depiction.

Computing device 900 may comprise at least one processor 902, a network adapter 904, and computer-readable storage media 906. Computing device 900 may be, for example, a desktop or laptop personal computer, a personal digital assistant (PDA), a smart mobile phone, a server, a wireless access point or other networking element, or any other suitable computing device. Network adapter 904 may be any suitable hardware and/or software to enable the computing device 900 to communicate wired and/or wirelessly with any other suitable computing device over any suitable computing network. The computing network may include wireless access points, switches, routers, gateways, and/or other networking equipment as well as any suitable wired and/or wireless communication media or media for exchanging data between two or more computers, including the Internet. Computer-readable media 906 may be adapted to store data to be processed and/or instructions to be executed by one or more processors 902. Processor 902 enables processing of data and execution of instructions. The data and instructions may be stored on the computer-readable storage media 906.

The data and instructions stored on computer-readable storage media 506 may comprise computer-executable instructions implementing techniques which operate according to the principles described herein. In the example of FIG. 9, computer-readable storage media 906 stores computer-executable instructions implementing various facilities and storing various information as described above. Computer-readable storage media 906 may store the various processes and facilities discussed above.

While not illustrated in FIG. 9, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

### EXAMPLES

The following illustrative examples are provided merely to facilitate a fuller understanding of some embodiments of some techniques described herein, and to demonstrate some ways in which some of the disclosed methods and system may be employed to address some particular technical problems. It should be appreciated that these examples do not represent the only modes of implementing techniques described herein, nor do they represent the only types of questions or problems which can be addressed. Accordingly, the specific questions/problems addressed, operational parameters described, methods or materials selected, and results obtained in the examples are presented by way of illustration. It should be appreciated that numerous alternative applications, modifications, combinations, and equivalents can be devised in other circumstances and in accordance with some techniques described herein.

### Example 1: Maritime Domain Awareness—Tracking Vessel Movements in Port X

### Overview of Maritime Domain Awareness

Maritime domain awareness entails establishing intelligence on vessel activities at ports and at sea. It is used in security and commercial applications to determine patterns of life for ships of interest by identifying vessels, their common routes and ports of call, transit speeds, and unique identifiers. It identifies suspicious activity such as ship-to-ship transfers, gaps in AIS transmissions, and indicators of dark vessels or other illegal activity such as unauthorized fishing. It also establishes an activity baseline at ports, restricted areas, and other places of interest.

Common sources for maritime activity data include SAR and EO sensor imagery, RF data, AIS data, and regional registries such as open source intelligence defense and commercial intelligence data sources, and other publicly available data (PAI). SAR and RF sensors, which allow for vessel detection under cloud cover and identification of vessel communications respectively, are obtained from commercial satellites. AIS geospatial data tracks vessel position and is sourced from commercial data sources. Commercial data for context depends on the region of interest and could include sources of open source commercial intelligence.

Ursa.next's analytics combine these data layers to identify some of the following maritime domain indicators for measuring activity:
Vessel routes, identification, and classification.
Gaps in AIS data
Path deviations.
Anomalous behavior

This allows Ursa.next to create deeper analytics that include a baseline picture of maritime activity and context, predictive route modeling, density analysis, and more. The platform is highly flexible in its ability to include diverse data sources.

### Maritime Problem to Solve.

Establish a baseline of activity at Port X for the past month.

### Developing a Prompt for the Solution

Narrowing down the query to activity related to specific objects can be helpful. The AI can also build solutions from requests using ambiguous language such as “suspicious behavior”.

Ursa.next UI suggests a natural language that will allow the AI-powered engine to define a scenario and collection requirements. The user enters the following prompt: “Track vessel movements in and around Port X over the last 30 days. Identify vessels deviating from normal routes or exhibiting suspicious loitering behavior. Note that the prompt contains an area of interest (Port X), a time (the last 30 days), and a topical focus (vessel movement, and in particular vessel deviations).

### Ursa.Next Solution

Ursa.next returns a map of the area of interest, with a boundary outlining the collection area and identified points of interest marked by pins. Each pin contains a summary of the indicator or object, along with contextual details. Ursa.next also returns a detailed summary of the data acquisitions, processing, and analytics used. It also presents a list of available analytical products and identified objectives that correspond to results displayed on the map. Users can select or deselect an objective to see how it aligns with objects pinned on the map.

For example, an Objective near a first location may be “assess the operational status and capabilities of the radar installation to determine its potential role in marine traffic monitoring and port operations interact. An example near a second location may be “assess the impact of Y installation on local maritime traffic patterns and port operations, focusing on vessel behavior modifications and potential security-related congestion.” An example near a third location may be “quantify and characterize port congestion patterns at Port X through comprehensive analysis of vessel density, wait times, and operational factors between February-March 2025.

The following is a section-by-section breakdown of the results for this specific use case.

### Data Acquisition

The solution lists all the recommended data sources to track vessel movement in Port X, along with their proposed collection frequencies and their purpose for collection. There is a mix of geospatial, commercial and open-source data.

| | Collection | |
|---|---|---|
| Data Source | Frequency | Application |
| AIS data feeds | Continuous | All vessel monitoring within |
| | | 50 nautical miles of port |
| SAR | Daily | Wide-area maritime |
| | | surveillance |
| spotlight SAR | One time task | Collections over high-interest |
| | | areas such as the shipyard and |
| | | military installations |
| nighttime imagery | One time task | Dark vessel detection |
| Commercial data source | One time task | Detailed vessel ID |
| Historical AIS data | Previous 12 | Establishing baseline for |
| | months | pattern analysis |
| Weather and sea state | Continuous | Environmental context |
| data | | |

### Data Processing

The data processing outlines how the data acquired will be processed to create data layers for analysis. Each data layer utilizes one or more data sources, allowing the platform to run complex and novel analytics on it.

| Processing | Data sources |
|---|---|
| Calibrate and georeference all | spotlight SAR |
| SAR imagery | |
| Apply radiometric corrections | WorldView-3 |
| to optical imagery | |
| Process nighttime imagery data | nighttime imagery |
| for nighttime light detection | |
| Perform automated vessel | spotlight SAR |
| detection on SAR imagery | |
| Clean and format AIS data | AIS data streams |
| streams | |
| Generate vessel density maps | AIS historical data |
| from historical AIS data | |
| Create baseline movement | AIS data streams and historical data, |
| patterns for major vessel | commercial data stores, weather |
| categories | and sea state |
| Fuse multi-source data (SAR, | SAR data streams, AIS data streams and |
| AIS, optical) for comprehensive | historical data, data stores |
| vessel tracking | |

### Data Analysis

Data analysis provides insight into higher level analytics run on processed data as a foundation for the reporting generated in the final stages. The summary lists analyses performed on the data acquired:
Execute dark vessel detection algorithms on SAR imagery.
Perform automated AIS transmission gap analysis.
Conduct behavioral pattern analysis for vessel movements.
Identify vessels deviating from established shipping lanes.
Analyze vessel clustering and potential rendezvous events.
Detect unusual anchoring or loitering patterns.
Compare current vessel behaviors against historical baselines.
Generate temporal heat maps of anomalous activities.
Correlate vessel movements with port operations schedules
Analyze nighttime vessel activities in restricted areas.

Reporting returns a list of available products for analysis and dissemination:
Generate daily situation reports of detected anomalies.
Create weekly pattern-of-life summary reports.
Produce vessel tracking maps with highlighted deviations.
Develop temporal analysis charts of port activity patterns.
Generate automated alerts for significant anomalies.
Create detailed reports on dark vessel activities.
Compile monthly trend analysis of behavioral patterns.
Prepare visualization packages of detected vessel clusters.
Document correlation between anomalies and port operations.

Results conclude with a list of objectives that are mapped to the visual components:
Detect and characterize anomalous vessel behaviors and dark vessel activities within the Port X area through comprehensive maritime pattern-of-life analysis.
Detect and characterize anomalous vessel behaviors and dark vessel activities within Port X area while establishing normal operational patterns through multi-source correlation of vessel movements and port activities.
Detect and characterize anomalous vessel behaviors and dark vessel activities within Port X and surrounding 50 nautical mile radius, with focus on deviations from established shipping patterns and unusual vessel interactions.
Identify and characterize vessel movements and training activities while monitoring their interactions with other vessels in the coastal waters, with particular focus on vessels A, B, C.
Monitor and characterize vessel movements and behavioral patterns around the shipyard and Port X, with emphasis on detecting activities related to naval operations and associated vessel movements.
Identify and characterize vessel movements and behavioral patterns potentially associated with military operations or suspicious activities near the reported installation, with particular focus on dark vessel detection and unusual movement patterns.
Identify and characterize vessel activities and behavioral patterns that may indicate surveillance or unusual interest in the radar installation, with particular focus on dark vessel operations and deviations from standard maritime patterns.
Identify and characterize military vessel movements and suspicious maritime activities around the installation at Port X, with particular focus on dark vessel detection and unusual behavioral patterns.

### What are the Benefits of the Solution?

The solution provides insight into port activity as it relates to multiple realms of interest and requirements, including surveillance capabilities and commercial vs military activities, while taking ongoing military installations into account during analysis. Indicators discovered also include dark vessel activity that are useful in identifying covert operations and planning further research. Reports allow for a quick briefing on port activity, with the ability to easily highlight anomalies and establish broad, high-level activity patterns.

In one further example of the Maritime Domain use case, a customer was suspicious that a certain oil tanker was conducting illegal ship-to-ship transfers (STS). In order to track the vessel of interest (VOI) and gather evidence of STS, Ursa Space utilized path forecasting. This method uses the ship's historical speeds, stated destination, and regional heat maps to offer trajectory predictions.

In one example of successful ship tracking utilizing path prediction analysis, an oil tanker was tracked which was suspected of conducting ship-to-ship transfers of oil with “dark ships”—or untracked vessels. Ursa Space can image and track VOI motion within a combination of signals such as overhead imaging data, AIS, track prediction and others.

For example, the data can be used to show a dark VOI loading cargo at offshore berth on March 2. The data shows the VOI beginning open water transit to a destination with AIS on March 4. Ursa Space can continue to track the VOI in motion using path forecasting until the STS occurs, for instance March 19-April 24th. Ursa Space can then capture the VOI undergoing STS with a dark vessel on March 10^{th} using, for example, a combination of overhead imaging, speed variance analysis for tracking ship-to-ship speeds, and other technique. In this way Ursa.next can generate a continuous chain of custody for determining the origination of the oil in the illegal oil transfer capture in an STS transfer.

### Example 2: Humanitarian Aid and Disaster Relief (HADR)—Wildfire Assessment in Los Angeles

### HADR Overview

Humanitarian Aid and Disaster Relief (HADR) covers monitoring of areas that have been affected by natural and other disasters. This coverage relies on combining geospatial, weather, infrastructure, open source and commercial data to establish a baseline picture of and assess near real-time changes in the affected area. Open-source data integration is a major component in providing useful HADR analysis.

Common sources for HADR collection include EO imagery from MSI or optical imagery and VIIRS, multispectral imagery from Sentinel-2 and Landsat, weather data from NOAA and Ventusky, and terrain data from elevation maps. Ursa.next also taps into a cache of baseline and historical data for previously monitored areas. Additionally, PAI/CAI data provide sources on critical infrastructure from OSM, population density, social media feeds, and more.

Data processing and analysis includes georeferencing imagery and performing multispectral analysis. Analytics are used to produce maps that incorporate PAI, FIRMS, VIIRS, weather, infrastructure, and imagery data. The variety of data sources provides context that informs recommendations for potential staging areas for response teams, plan delivery and aid routes, predict future damage and mitigate risk, and avoid blocks and other dangers.

### HADR Problem to Solve.

Assess the damage from recent wildfires in the Los Angeles area and stay abreast of possible obstructions and relevant data that will impact relief efforts.

### Developing a Prompt for the Problem

Ursa.next UI suggests a natural language that will allow the AI-powered engine to define a scenario and collection requirements. The user enters the following prompt: “detect and track active fire perimeters within 25 miles of Los Angeles from the past 2 months. Provide real-time updates on fire spread.” Note that the prompt contains an area of interest (25-mile radius from Los Angeles), a time period (2 months), and a topical focus (active fire perimeters).

### Ursa.Next Solution

The platform returns to a readable summary of its results and a map of the area of interest. The map contains identified points of interest such as wildfires, critical infrastructure, and public activity. Each pin contains a summary that defines its collection objective, along with any contextual information. Selecting or deselecting an objective allows the user to see how it corresponds with objects pinned on the map. Sample objectives may include “assessing wildfire impacts and emergency response effectiveness in the Hawthorne/Crenshaw Boulevard area during Q1 2025, with particular attention to critical infrastructure and evacuation route accessibility”, “assess wildfire impact and risks to San Pedro Fuel Depot during Q1 2025 fire events, with emphasis on facility safety, evacuation routes, and environmental consequence”, and “assess wildfire impacts on John Wayne Airport operations and infrastructure during Q1 2025, with emphasis on its role in emergency response and evacuation efforts.

A human readable summary may be shown left of the map with a breakdown of the Ursa.next solution, broken down by data acquisitions, processing, analytics, and results. It concludes with a list of available analytical products, identified objectives, and options for further steps.

### Data Acquisition

The solution lists all of the recommended data sources to conduct wildfire assessment around the Los Angeles area, along with their proposed collection frequencies and their purpose for collection. There is a mix of geospatial, commercial and open-source data.

| Data Source | Collection Frequency | Application |
|---|---|---|
| Geospatial data | 6-hour intervals | Broad area fire detection |
| continuous | | |
| monitoring | | |
| Geospatial data | Daily | Monitor active fire areas |
| Geospatial data | Continuous monitoring | Smoke plume tracking |
| Geospatial data | Schedule for every | SAR-based monitoring |
| | 12 hours | |
| Geospatial data | One time task | Imagery for critical |
| spotlight | | infrastructure |
| collections | | |
| Commercial data | One time task | Terrain analysis |
| store | | |
| Weather data | Real-time feeds | Wind, temperature, humidity |
| from multiple | | |
| sources | | |
| Historical or | One time task | Baseline fire perimeter data |
| archival data | | and vegetation maps |

### Data Processing

The data processing outlines how the data acquired will be processed in order to create data layers for analysis. Each data layer utilizes one or more data sources, allowing the platform to run complex and novel analytics on it.

| Processing | Data sources |
|---|---|
| Perform radiometric calibration | Geospatial data |
| of thermal and optical imagery | |
| Execute atmospheric correction | Geospatial data |
| for smoke detection accuracy | |
| Process SAR data for soil | High resolution spotlight |
| moisture and burn scar analysis | collections |
| Generate digital terrain models | Commercial data store |
| and slope maps | |
| Create NDVI baselines for | Archival data, |
| vegetation health monitoring | |
| Implement automated co-registration | Geospatial data |
| of multi-sensor data | |
| Calculate burn severity indices | Archival data, Geospatial |
| from pre/post-fire imagery | data |
| Process weather data for fire | Weather data |
| behavior modeling | |

### Data Analysis

The data analysis section lists the higher-level analytics to be run on processed data. These results will utilize AI assistance to generate indicators and insights that provide the foundation for final reporting. The summary lists the following suggested analyses for monitoring wildfires around Los Angeles:

Analytic

Execute automated fire hotspot detection algorithms (6-hour intervals)
Perform smoke plume modeling and trajectory prediction
Calculate fire spread vectors using terrain and weather data
Assess burn severity and update fire perimeter maps daily
Analyze vegetation health in fire-prone areas
Evaluate soil moisture conditions affecting fire risk
Model potential fire spread scenarios near critical infrastructure
Assess urban interface vulnerabilities
Generate predictive fire behavior models

### Reporting

The reporting section returns a list of available products that can be created for dissemination and further analysis. Reporting products can be a single instance or repeating, depending on the user's needs, and are independent of each other, allowing users to select them as needed.

Reporting

Generate automated 6-hour situation reports with fire perimeter updates
Produce real-time alert notifications for new fire detections
Create daily summary maps of fire activity and progression
Compile meteorological forecast integration reports every 12 hours
Develop infrastructure-specific threat assessments every 6 hours
Generate smoke dispersion forecasts for aviation safety
Prepare weekly trend analysis of fire activity and environmental conditions

### Objectives

Finally, a list of collection objectives completes the summary. These objectives correspond to the map and provide the user with clarity on interpreting the results. The objectives provide insight into how Ursa.next categorizes points of interest and events that are identified on the map. To see how objects pinned on the map correspond to specific objectives, the user selects or deselects the checkmark beside the written objective which adds and removes the corresponding pins, respectively.

Objective

Monitor and assess fire-related risks in the protest area along Crenshaw Boulevard near SpaceX
headquarters, with emphasis on early detection of fire threats and ensuring emergency response
access.
Monitor wildfire activity and potential impacts of civil unrest on emergency response
capabilities within the Los Angeles area, with emphasis on identifying fire risks near protest
zones and maintaining clear emergency access routes.
Monitor and assess wildfire threats to John Wayne Airport operations and infrastructure, with
emphasis on early detection and impact analysis on air operations.
Monitor and assess wildfire risks and impacts at Hawthorne Municipal Airport and surrounding
area to support emergency response planning and ensure operational continuity.
Monitor and assess wildfire threats to San Pedro Fuel Depot with emphasis on early warning and
risk mitigation for critical fuel storage infrastructure.

### Discussion of the Solution

The solution Ursa.next created for this task allows for a quick visual assessment of the spread of wildfires juxtaposed with important logistical and infrastructure sites, such as airports and fuel depots. In addition, results integrate open-source data such as protests and other known activities, which assists in planning and mitigation. The visual component allows users to view clusters of wildfires and make rapid initial assessments of the scope of damage, concentration and spread. Analytics assess the damage of an affected area, which is useful in defining zones of interest, monitoring evacuation routes for people, and planning for resource allocation. The rapid turnaround supports dynamic decision-making in a situation experiencing frequent change.

The extensive summary provides clarity and transparency on the data collection, tasking, processing, and analytical process. This allows users without a background in geospatial intelligence or GIS to utilize these tools at a high level with the assurance of their robust foundations. Users can take what they need from this solution, whether that be the recommended data collections, the analytic results, final reports, or some combination of all of them.

Additional projects include Taiwan Earthquake Damage Assessment, Hurricane Ida Refinery Flooding Assessment, and Ukraine Electric Grid Damage Assessment

### Example 3: Border Monitoring-Detecting Vehicle Movement on the Oman-Yemen Border Over the Past 6 Months

### Overview of Border Monitoring

The goal of border monitoring is to locate, identify and classify human and infrastructure activity at and around borders of interest. It is critical in security and defense applications and is used to track and identify a variety of known types of border activity, including unauthorized crossings, smuggling and trafficking, and violent extremist activity. In addition to human patterns, it also tracks infrastructure changes over time, such as the construction of new routes. Border monitoring overlaps with other areas of geospatial analysis, including humanitarian crises and emergency response, where it provides critical data and analysis for response planning.

Common data sources for border monitoring data include SAR and EO sensor imagery, detailed elevation maps (DEMs), open-source data from sources and other publicly available data (PAI). SAR, open source and commercial data provide a rich tapestry of data layers which include radio frequency activity, population density, nighttime activity, weather patterns, historical patterns, and more.

Ursa Space's analytics employ change detection and manmade target detection algorithms, as well as AI assistance, to identify and measure a variety of established and verified indicators such as camps, vehicles, manmade structures, road and rail networks, tunnels, and more. It also combines this with changes in landscape features and contextual information to provide an overall picture of border activity and provide data on real-time anomalies, refugee camps, infrastructure and population changes, and terrain changes.

One level further, it visualizes the analytic outputs and ground detections and produces a deeper analysis by delivering risk assessments and reporting on potential high-risk activities.

### Border Monitoring Problem to Solve

Monitor vehicle movement on the Oman-Yemen border.

### Developing a Prompt for the Problem

The Ursa.next UI suggests a natural language that will allow the AI-powered engine to define a scenario and collection requirements. The user enters the following prompt: “detect and analyze vehicle movement within 25 miles of the Oman-Yemen border from the last 6 months.” Note that the prompt contains an area of interest (25-mile radius from the Oman-Yemen border), a time period (6 months), and a topical focus (vehicle movement).

### Ursa.Next Solution

The platform may return a human readable summary of its results and a map of the area of interest. The map may contain identified points of interest such as camps, villages, border crossing points, roads and routes. Each may pin corresponds to a high level collection objective identified with AI assistance. Selecting or deselecting an objective allows the user to see how it corresponds with objects pinned on the map.

For example, an objective associated with the map may show objectives such as “Determine if the remote Omani village is being used as a VEO logistics hub or staging area by analyzing structure development, movement patterns, and cross border activities” associated with an Omani village location. Another objective, such as one associated with a border location, may be “determine if the increased infrastructure development at the remote border crossing represents VEO support facilities by analyzing both physical changes and associated activity pattern.” Another objective associated with a border crossing may be “detect and characterize potential CEO activities at and around the Shahan-Al Mazyunah border crossing by identifying suspicious movement patterns, unauthorized crossing attempts, and supporting infrastructure within a 10 km radius of the crossing point. A summary may contain a breakdown of the Ursa.next solution organized into data acquisitions, processing, analytics, and results and a list of available analytical products, identified objectives, and options for further steps.

### Data Acquisition

The solution lists all of the recommended data sources to track vehicle movement around the Oman-Yemen border, along with their proposed collection frequencies and their purpose for collection. It uses a mix of SAR satellite imagery that includes strip map and spotlight views to obtain both broad coverage and close-up coverage of specific features. Ursa.next has the benefit of being able to optimally task satellite vendors to establish collection schedules that best address the various features to track, i.e. border crossing points, military facilities, vehicles:

| | Collection | |
|---|---|---|
| Data Source | Frequency | Application |
| 50 KM SAR | 3-day intervals | Initial 25-mile buffer zone |
| | | coverage |
| high-resolution | Every 12 hours | Close-up of border-crossing |
| SAR | | points |
| FINE SAR | Daily | Monitoring of known |
| | | military facilities (Sarafayt |
| | | Camp, Mazyona Camp) |
| 25 CM SAR | Alternating day/night | Detailed vehicle monitoring |
| | collection | |
| Geospatial data | Continuous | Broad-area change detection |

### Data Processing

The data processing section outlines how the data acquired will be processed in order to create data layers for analysis. Each data layer utilizes one or more data sources, allowing the platform to run complex and novel analytics on it:

| Processing | Data sources |
|---|---|
| Perform radiometric calibration and terrain | All |
| correction on all SAR imagery | |
| Co-register multi-temporal images for | SAR data |
| change detection analysis | |
| Generate digital elevation model (DEM) | SAR data, Geospatial data |
| masks to account for terrain effects | |
| Apply speckle filtering optimized for vehicle | SAR data |
| detection | |
| Create temporal stacks for pattern analysis | SAR data |
| Implement automated vehicle detection pre- | SAR data |
| processing | |

### Data Analysis

The data analysis section lists the higher-level analytics to be run on processed data. These results will utilize AI assistance to generate indicators and insights that provide the foundation for final reporting. The summary lists the following analyses used to address vehicle monitoring at the Oman-Yemen border:

Analytic

Execute MANTIS (Man-Made Target in SARs) processing to detect and characterize vehicles
across all scenes
Apply Object Detection algorithms to classify vehicles (civilian/commercial/military)
Perform Non-coherent Change Detection (NCD) to identify new routes and activity patterns
Generate Two Color Multiview (TCMV) products to visualize temporal changes
Conduct automated pattern analysis to establish baseline traffic patterns
Apply behavioral anomaly detection to identify unusual movement patterns
Create activity heat maps showing vehicle congregation points
Analyze day vs night activity differences using temporal comparison

### Reporting

The reporting section returns a list of available products that can be created for dissemination and further analysis. Reporting products can be a single instance or repeating, depending on the user's needs, and are independent of each other, allowing users to select them as needed.

Reporting

Generate daily vehicle movement summary reports with classification statistics
Produce weekly pattern analysis reports highlighting trends and anomalies
Create geospatial overlays showing primary and secondary movement corridors
Develop temporal activity charts comparing day/night patterns
Compile vehicle congregation point analysis with dwell time statistics
Prepare monthly assessment of changes in movement patterns
Generate automated alerts for significant deviations from baseline patterns
Maintain the running database of vehicle classifications and movement statistics

### Objectives

A list of collection objectives completes the summary. These objectives correspond to the map and provide the user with clarity and insight into how Ursa.next categorizes points of interest and events that are identified on the map. To see how objects pinned on the map correspond to specific objectives, the user selects or deselects the checkmark beside the written objective which adds and removes the corresponding pins, respectively.

Objective

Detect and characterize vehicle movement patterns and infrastructure changes at the remote
Oman-Yemen border crossing, with emphasis on identifying vehicle types, routes, and
temporal patterns over the specified month-long period.
Detect and characterize changes in vehicle movement patterns and congregation points around
the remote Omani village, with emphasis on correlating these patterns with newly identified
structures.
Establish comprehensive ground vehicle movement patterns and identify potential
unauthorized crossing activities at the Shahan-Al Mazyunah border crossing through detection,
classification, and temporal analysis of vehicle movements.
Detect and characterize vehicle movement patterns and checkpoint operations at Sarfait border
crossing, with emphasis on identifying unofficial transit routes and distinguishing between
civilian, commercial, and military traffic.
Analyze vehicle movement patterns and operational tempo at Sarafayt Camp and its immediate
vicinity (5 km radius) to establish baseline military activity patterns and identify potential
changes in operational status.
Analyze military vehicle movement patterns and operational tempo at and around Mazyona
Camp, with emphasis on detecting changes in activity levels and identifying regular patrol
routes.

Additional tracking of the Yemen Oman Bordar can include monitoring roadside camps & checkpoints, detecting cross-border paths & trails, tracking vehicle movements & staging areas, detecting human smuggling activities, and identifying new communication Setups.

Example Objectives: Detect and Analyze Vehicle Movement within 25 Miles of the Oman-Yemen Border from the Last 6 Months.

Recent intelligence indicates significant security concerns along the Oman-Yemen border region, particularly regarding weapons trafficking and illicit drug trade. On Mar. 24, 2025, customs officials at the Sarfit crossing near the Omani border seized over 800 unmanned aerial vehicles (UAVs). While authorities did not explicitly identify the intended recipients, this seizure occurs in the context of known cross-border weapons trafficking attempts by Ansar Allah militants, suggesting a potential connection to regional militant activities. This represents a substantial interdiction of technology that could be weaponized for military purposes.

### Time of Interest

Historical data from Nov. 5, 2024 through May 5, 2025

### Data Fusion Objective

This objective will analyze vehicle movement patterns within a 25-mile radius of the Oman-Yemen border over the past 6 months using multi-source intelligence fusion. By combining SAR imagery, RF signal detection, and change detection analytics, we will identify key transportation corridors, vehicle concentration areas, and temporal patters of cross-border movement. The analysis will focus on distinguishing between routine civilian traffic and potentially suspicious movement patterns that may indicate smuggling, trafficking, or other illicit activities. Special attention will be given to the areas surrounding Al Mazyunah and the Sarfit crossing, where previous security incidents have been reported, as well as other hotspots of activity identified along the border region.

### Data Fusion Objective

This objective conducts a temporal analysis of vehicle movement patters along secondary routes and unofficial crossing points within 25 miles of the Oman-Yemen border. While the existing objective focuses on primary transportation corridors and known crossing points, this complementary analysis will identify seasonal variations, nighttime movement patterns, and potential smuggling routes through less monitored areas. By combining medium-resolution SAR imagery with RF signal detection and historical event data, we will establish temporal baselines of vehicle activity and identify anomalous movement patterns that may indicate illicit cross-border activities. Special attention will be given to areas surrounding Shahan District and other remove border regions where previous security incidents involving smuggling have been reported, as these areas may serve as alternative routes when primary routes are not available.

Recent intelligence indicates significant security concerns along the Oman-Yemen border region, particularly regarding weapons trafficking and illicit drug trade. On Mar. 24, 2025, customs officials at the Sarfit crossing near the Omani border seized over 800 unmanned aerial vehicles (UAVs). While authorities did not explicitly identify the intended recipients, this seizure occurs in the context of known cross-border weapons trafficking attempts by Ansar Allah militants, suggesting a potential connection to regional militant activities. This represents a substantial interdiction of technology that could be weaponized for military purposes.

Earlier, on Nov. 27, 2024, security forces in Shahan District within Al Mahrah Governorate intercepted 200 kg of hashish intended for international distribution. No arrests were reported in connection with this seizure, indicating the possible evasion of traffickers despite the confiscation of contraband. These incidents demonstrate ongoing challenges in border security despite active enforcement efforts.

The Royal Army of Oman maintains a military presence in the region through two active bases: Mazyuna Camp near Al Mazyunah (population approximately 10,000) and Sarafayt Camp. These installations likely serve as strategic positions for monitoring and responding to cross-border threats. Persistent human activity has been detected through multiple sources, with particularly high concentrations observed in the vicinity of Al Mazyunah and the surrounding military installations. Activity hotspots with intensity levels ranging from approximately 158 to 7.6 have been recorded across the region, with the most significant clusters centered around coordinates 52.68° E, 17.84°N, corresponding to areas near the Mazyona Camp.

The pattern of illicit trafficking attempts, combined with the strategic positioning of military bases and concentration of human activity near border areas, suggests an ongoing security situation requiring continued vigilance. The seizure of both narcotics and potential weapons systems indicates diverse smuggling operations that may be exploiting vulnerabilities along the border region despite the presence of security forces.

### Data Fusion Objective

This objective will analyze vehicle movement patterns within a 25-mile radius of the Oman-Yemen border over the past 6 months using multi-source intelligence fusion. By combining SAR imagery, RF signal detection, and change detection analytics, we will identify key transportation corridors, vehicle concentration areas, and temporal patters of cross-border movement. The analysis will focus on distinguishing between routine civilian traffic and potentially suspicious movement patterns that may indicate smuggling, trafficking, or other illicit activities. Special attention will be given to the areas surrounding Al Mazyunah and the Sarfit crossing, where previous security incidents have been reported, as well as other hotspots of activity identified along the border region.

### End Deliverable

A comprehensive assessment of vehicle movement patterns along the Oman-Yemen border region, identifying key transportation corridors, temporal patters, and anomalous vehicle activities. This deliverable will provide intelligence on cross-border traffic flows, potential smuggling routes, and areas of concentrated vehicle activity that may warrant further monitoring. The analysis will include detection of vehicle convoys, identification of frequently used unofficial crossing points, and correlation of vehicle movements with known security incidents in the region.

### Visualization to Create:

### Movement Tracks

Lines or paths overlaid on a map showing the recorded movement of individuals or vehicles involved in unauthorized crossings.

### Supporting Data Sources, Analytics, and Satellite Imagery

High Resolution SAR Image with Annotations
Medium Resolution SAR Image with Annotations
Ursa Space's MANTIS Analytic
Ursa Space's Object Detection Analytic
Ursa Space's Coherent Change Detection Analytic
Ursa Space's Non-coherent Change Detection Analytic
Vendor X Signal Detection
Vendor Y RF Signal Monitoring

### Supporting Data Sources, Analytics, and Satellite Imagery

Resolution SAR Image with Annotations
1 m Spotlight (100 cm resolution)
50 cm Spotlight (50 cm resolution)
35 cm Spotlight (35 cm resolution)
25 cm Spotlight (25 cm resolution)
Spotlight Ultra (25 cm resolution)
Spotlight (50 cm resolution)
Spotlight Wide (100 cm resolution)
Spot Fine (10 cm resolution)
Spot (25 cm resolution)
Spot Extended Area (50 cm resolution)
Tasks for Analysts
Collect and analyze high-resolution SAR Imagery over key border crossing points and transportation corridors to detect and classify vehicle movements
Apply Ursa Space's MANTIS and Object Detection analytics to identify vehicle concentrations and distinguish between different vehicle types (civilian, commercial, potential military)
Utilize coherent change detection (CCD) to identify subtle changes in terrain that may indicate new or expanding transportation routes or unofficial crossing points
Correlate RF signal data from Vendor X with detected vehicle movements to identify potential patterns of communication associated with cross-border activities
Analyze temporal patterns of vehicle movement to identify peak activity periods, regular patterns, and anomalous movements across the border region
Create movement track overlays showing primary and secondary transportation corridors, with heat maps indicating frequency and volume of detected vehicle activity
Compare detected vehicle movements with known security incidents reported by Janes to identify potential correlations between vehicle patterns and illicit activities
Develop a classification system for vehicle movement patterns to distinguish between routine civilian traffic, commercial transport, and suspicious movement patterns
Generate time-series analysis of vehicle activity at key hotspots to identify trends and changes in movement patterns over the 6-month period
Produce a final assessment report with annotated maps highlighting the key findings, areas of concern, and recommendations for continued monitoring

### Area of Interest Overview

The Oman-Yemen border is a critical reg ion for monitoring cross-border movement. illicit activities, and Violent Extremist Organization (VEO) facilitation networks The AREA OF INTEREST includes key urban centers, strategic border crossings, and significant geographic features that impact operational awareness and security considerations. The combination of rugged desert terrain, remote wadi systems, and minimal border infrastructure provides both challenges and opportunities for monitoring illicit activity.

### Urban Centers & Key Hubs

Salalah, Oman (17,01972°N, 54.08972° E): The largest city in the Dhofar Governorate and a major logistical hub for trade and security operations. Its proximity to the Yemen border makes it vital for monitoring cross-border smuggling and extremist movement.

### Strategic Border Crossing & Transit Routes

Al Mazvunah Border Crossing (07.83333°N. 52.75000° E): An official border crossing between Oman and Yemen, facilitating trade and legal movement. However, illicit actors exploit gaps in monitoring to bypass security controls.

Sarfait Border Post (16.65000°N. 53.00000° E): A remote mountainous checkpoint. often used to monitor illicit crossings and potential VEO activity. Limited security presence makes it a vulnerable transit corridor.

Shahan Yemen (17.33333°N. 52.20000° E): A town near key informal crossings, frequently used by smugglers and extremist groups. Terrain features provide natural concealment for movement.

### Terrain Analysis Summary

The Oman-Yemen border remains a critical area for monitoring due to the presence and movement of violent extremist organizations (VEOs). The region's rugged terrain, limited state presence, and porous border facilitate illicit cross-border movement. including arms smuggling, militant transit, and logistical resupply routes. Given Oman's stability and strategic importance, VEOs seek to exploit gaps in border security for operational advantage.

Geographic Context: The area of interest covers the eastern Yemen governorates of Al Mahrah and Hadramaut, along with Oman's Dhofar region, a key border corridor for movement between the two countries. Terrain Considerations: The area of interest includes a mix of desert, mountainous terrain, and wadis, which provide concealment for illicit movement. Border security infrastructure is sparse, with limited official crossing points.

### Geographic & Terrain Considerations for High Priority Locations

Wadi Mitan (18.70917°N. 52.58472° E): A significant dry riverbed running through the border region, historically used as a smuggling route. Its isolated nature makes it difficult to monitor.

Wadi Ghadun (18.53333°N. 53.68333°E): Located in the Dhofar region, this terrain feature provides concealment and facilitates movement of personnel and goods across the border.

### Activity Density Summary

### Key Vehicle/Man-Made Activity Patterns

### Image Summary

Density visualization of vehicle movements in key AREA OF INTEREST locations.

### Key Observations

Increased detections of man-made activity in remote border zones.

Clustered movement near logistics hubs (Salalah, Al Mazyunah, Shahan).

Clusters near official border crossings {Al Mazyunah, Sarfait).

Unusual man-made activity in previously low-traffic areas.

### Operational Implications:

Potential rise in organized smuggling networks.

Movement patterns suggest coordination with cross-border actors.

### Activity Density Analysis

### Key Vehicle/Man-Made Activity Patterns

### Image Summary:

Annotated image with specific high-activity zones marked.

### Key Observations:

Analysis of high-frequency movement corridors.

Identified anomalous travel patterns near the border.

### Operational Implications:

Heightened potential smuggling activity detected.

Requires focused surveillance & interdiction efforts.

### Change Activity Analysis

### Key Observations

The image represents a heatmap of Sentinel-1 change detection polygons.

Areas with high-intensity changes correlate with suspected official border crossings.

Concentrations of change polygons along border transit corridors suggest movement or construction activities.

Clusters near known smuggling hubs indicate potential new infrastructure or modifications to existing routes.

Persistent changes in high-risk areas of interest may indicate shifting smuggling patterns or expansion of unmonitored routes.

### Example 4: Economic Monitoring

### 1. Monitoring Global Oil Inventories

Global energy markets lack transparency. Traditional oil storage data is often outdated, geographically limited, and inconsistent in accuracy.

Ursa Space overcomes these challenges by leveraging a cloud-based platform and virtual constellation of radar satellites to deliver reliable, weekly oil storage measurements.

### 2. Stockpile Measurements

Stockpile data is important for trading and forecasting. Traditional methods rely on outdated technologies with significant limitations. Leveraging SAR, Ursa Space has developed a 3D reconstruction technique using high resolution imagery to measure stockpiles. This provides precise, all-weather, weekly measurements, empowering our customers to track inventories with confidence.

### Market Disruption

Leveraging our experience in military surveillance and commodity data, Ursa Space monitors indicators of conflict preparation, such as troop deployments, hardware movements, resource stockpiling, and more. This can indicate preparedness for large-scale military action to gauge potential market risks, supply disruptions, and geopolitical instability. Russi Customers can incorporate risk metrics into their strategies and stay ahead of market-moving events.

### Example 5: Site Monitoring

6.1: Assessing Saudia Arabia crude oil inventories; assess damage and monitor repairs of the Abquaqu and Khurais oil processing facilities.

### Location: Abqaiq Oil Processing Facility

Ursa Space was tasked with assessing damage and monitoring repairs after the 2019 attacks on the Abqaiq and Khurais oil processing facilities and was able to track the status of the spherical tanks and oil processing train.

Ursa Space also provided updates on Saudi Arabia's crude oil inventories, using satellite imagery to track a rebound after a sharp drawdown following the attack.

6.2 Luiswishi Copper and Cobalt Mine extraction activity and production volumes. A mining company asked Ursa Space to gauge extraction activity and production volumes at the Luiswishi copper and cobalt mine. This project utilized several change detection and measurement approaches to monitor material extraction and heavy mining equipment.

### Example 6: Human Observables at Borders of Interest

Objective: Monitor and detect human/vehicle activity across borders.

### Key Outputs:

Heatmap of activity patterns
Detection of unauthorized crossings
Vehicle classification (civilian, military)

Data Sources: SAR imagery, border crossing records, RF and AIS tracking.

### Indicators:

Human Activity

### Encampment Detection

Detects long-term structures and shelters appearing in SAR imagery.

Flags newly appeared or disappeared encampments in recent imagery

### Footpath Formation

Identifies well-established paths with consistent SAR backscatter.

Detects new or increased footpath formation in non-road areas.

### Cross-Border Human Movement

Tracks persistent infrastructure (bridges, roads, known illegal crossings).

Detects new crossings or sudden

### Gathering Points/Staging Areas

Detects known structures, fences, and enclosed areas where groups congregate.

Highlights changes in areas where activity is increasing or decreasing.

### Unusual Movement in Remote Terrain

Establishes a static baseline of human activity near settlements or roads.

Identifies new movement in previously inactive zones.

Vehicle Activity

### Off-Road Vehicle Tracks

Detects roads, established dirt paths, and persistent vehicle routes.

Flags new off-road tracks that suggest illicit smuggling activity.

### Clandestine Border Crossings

Identifies static infrastructure like gates, checkpoints, and controlled roads. Highlights vehicles moving in areas without established roads.

### Temporary Vehicle Staging Areas

Detects persistent vehicle parking areas near known smuggling routes.

Flags sudden surges in vehicle presence where there were none before.

### High-Speed or Evading Vehicles

Identifies roadways and infrastructure where high-speed travel is possible.

Highlights new, erratic vehicle movement patterns suggesting evasion.

### Tunnels or Concealed Roadways

Detects persistent road structures that remain over time.

Flags sudden terrain changes or modifications indicative of tunnel entrances.

Anomaly Detection for Illicit Border Activity

### Illicit River Crossings (Small Boats or Rafts)

Detects persistent piers, launch points, or crossings.

Flags changes in waterway terrain, suggesting active crossings.

### Sudden Migration Surges

Establishes static footbath/trail networks in SAR data.

Highlights new or intensified footpath usage in unexpected areas.

### Smuggling Convoys

Identifies vehicle routes and parking areas.

Detects sudden new roads or multiple vehicles moving at once.

### Border Fence Tampering/Breach Points

Detects long-standing border fence structures.

Flags breaks or disruptions in SAR signature near fences.

### New Smuggling Infrastructure (Buildings, Warehouses, Staging Areas)

Identifies existing warehouses, checkpoints, and road networks.

### Example 7: Abnormal Military Activity Around the Black Sea

In some embodiments, a requester 105 can log into the geospatial system 100 and access a recommended case or enter a new use case. If the geospatial system 100 recognizes the use case, the geospatial system may recommend time-relevant prompts to the requester

Query: Abnormal Vessel Activity within 50 km of the Black Sea Coast in the Last 7 Days

The Black Sea region encompasses a complex geographical landscape with significant military strategic importance. Analysis of the provided locations reveals several key patterns and findings across neighboring countries.

Istanbul, Turkey stands as the dominant urban center in the region with a population of over 16 million, serving as a critical maritime gateway through the Bosphorus Strait. The Turkish coastline is heavily populated, with numerous cities and districts forming a dense urban corridor, particularly around Istanbul and along the Black Sea coast. Major Turkish naval facilities are located in Istanbul, Trabzon, and other coastal cities, highlighting Turkey's maritime presence in the region.

Port infrastructure is well-developed throughout the Black Sea, with major commercial and military ports along the Black Sea. These ports serve as critical notes for both military operations and commercial shipping, connecting the Black Sea to global maritime routes.

Recent thermal hotspot detections by NASA FIRMS indicate potential military activity or industrial operations, particularly around Novorossiysk port and in southern Ukraine. Dark vessel activity reported by Ursa Space suggest possible unauthorized maritime movement, especially along the Turkish and Georgian coastlines, which may indicate smuggling operations or other illicit activities.

The region's strategic significance is further underscored by the presence of specialized facilities, including nuclear installations in Turkey, teleport/ground stations for satellite communications, and extensive early warning sensor networks. These elements collectively form a complex security environment where military, commercial, and civilian infrastructure are closely intertwined across multiple national boundaries.

Time of Interest: Historical data from Apr. 28, 2025 through May 5, 2025

### Data Fusion Objective

This objective aims to identify and analyze abnormal vessel activity within 50 km of the Black Sea coast over the past 7 days. By fusing SAR imagery, vessel tracking data, and RF signal detection, we will identify vessels operating with suspicious behavior patterns, particularly those operating without AIS transponders (dark vessels). The analysis will focus on detecting unusual movement patterns, unauthorized stops, potential ship-to-ship transfers, and vessels loitering in restricted areas. This objective is necessary to provide comprehensive maritime domain awareness along the Black Sea coast, where increased abnormal vessel activity has been detected in recent days, particularly near strategic ports like Novorossiysk, Odessa, and Sevastopol.

### End Deliverable

A comprehensive analysis of suspicious maritime activity within 50 km of the Black Sea Coast, focusing on dark vessel detection, unusual movement patterns, and potential illicit activities. This deliverable with identify vessels operating without AIS transponders, vessels exhibiting unusual navigational patterns, unauthorized stops in restricted areas, and potential ship-to-ship transfers. The analysis will correlate SAR-detected vessels with AIS data to identify discrepancies and highlight areas with concentrated abnormal activity.

### Data Fusion Objective

This objective aims to conduct a detailed analysis of vessel rendezvous activities and potential ship-to-ship transfers within 50 km of the Black Sea coast over the past 7 days. By fusing SAR imagery with RF signal detection and historical vessel tracking data, we will identify instances where vessels meet at sea for extended periods, particularly areas with high concentrations of dark vessel activity. The analysis will focus on detecting patterns consistent with illicit transfers, including vessels that slow down or stop in close proximity to each other, vessels that deviate from standard shipping routes to meet, and vessels that exhibit coordinated movements. This objective is necessary to complement the existing dark vessel detection analysis by specifically targeting the interactions between vessels that may indicate smuggling, illegal transfers, or other illicit maritime activities. The analysis will focus particularly on the identified hotspots near the Turkish coast (around coordinates 36.56, 41.75 and 41.70) where Ursa Space has detected significant dark vessel activity.

### End Deliverable

A comprehensive analysis of vessel rendezvous activity and potential ship-to-ship transfers within 50 km of the Black Sea coast. This deliverable will identify patterns of suspicious maritime interactions, focusing on vessels that meet at sea for extended periods, particularly in areas with high concentrations of dark vessel activity. The analysis will correlate vessel movements, communication patterns, and historical data to distinguish between legitimate maritime operations and potential illicit activities such as smuggling or unauthorized transfers. Special attention will be given to the high-activity areas identified near the Turkish coast where significant dark vessel activity has been detected.

### Visualization to Create

### Multi-Layer Map

A map combining multiple geospatial layers like imagery, vector overlays, or AIS tracks.

### Supporting Data Sources, Analytics, and Satellite Imagery.

The geospatial system 100 may translate the request to a series of steps, tasks, and/or actionable queries. For instance, the geospatial system may generate steps to collect data and compare with expected baselines.

### Tasks for Analysts

Collect and analyze medium and low-resolution SAR imagery covering the Black Sea coastal areas within the specified time period (Apr. 28-May 5, 2025)
Process SAR imagery using Ursa Space's vessel detection analytics to identify all vessels within 50 km of the Black Sea coast.
Obtain AIS data for the same time period and geographic area to establish baseline of normal vessel traffic
Cross-reference SAR-detected vessels with AIS data to identify dark vessels (those visible to SAR but not broadcasting AIS)
Analyze RF signal date to detect and geolocate potential maritime communications from vessels attempting to hide their presence
Apply Ursa Space's Two Color Multiview (TCMV) and Colored Subaperture Image (CSI) analytics to detect vessel movement patterns and identify suspicious behavior
Create density maps of dark vessel activity and identify hotspots of abnormal maritime activity
Analyze vessel behavior patterns to identify potential ship-to-ship transfers, loitering in restricted areas, or unusual navigation routs.
Compare current activity patterns with historical data to distinguish between normal fishing operations and potential illicit activities
General a multi-layer map visualization showing detected vessels, their AIS status, movement patterns, and identified anomalies
Prepare detailed report on abnormal vessel activity, including specific vessels if interest, activity hotspots, and recommended areas for further monitoring

### End Deliverable

A comprehensive analysis of vessel rendezvous activity and potential ship-to-ship transfers within 50 km of the Black Sea coast. This deliverable will identify patterns of suspicious maritime interactions, focusing on vessels that meet at sea for extended periods, particularly in areas with high concentrations of dark vessel activity. The analysis will correlate vessel movements, communication patterns, and historical data to distinguish between legitimate maritime operations and potential illicit activities such as smuggling or unauthorized transfers. Special attention will be given to the high-activity areas identified near the Turkish coast where significant dark vessel activity has been detected.

### Visualization to Create

### Pattern Recognition Map

Specialized map highlighting suspicious or unusual patterns like loitering or rendezvous.

### Supporting Data Sources, Analytics, and Satellite Imagery

Medium Resolution SAR Image with Annotations
High Resolution SAR Image with Annotations
AIS Vessel Positions
RF Signal Detection
RF Maritime Detection
Ursa Space's Vessel Detection Analytic
Ursa Space's Colored Subaperture Image Analytic
Ursa Space's Video SAR Analytic
Ursa Space's Two Color Multiview Analytic

The geospatial system 100 may determine the appropriate data and tasking for its resources and may automate the data acquisition, processing, and analytics.

What is claimed is:

1. A computer-implemented method comprising:
processing a natural language query, using at least one model, to identify one or more sets of operations for data collection and analysis from a plurality of sets of operations for data collection and analysis, each of the plurality of sets of operations for data collection and analysis associated with a domain and each of the plurality of sets of operations for data collection and analysis comprising at least one data collection operation for overhead imagery data;
identifying, based on the one or more sets of operations for data collection and analysis, data to be collected for performing an analysis in response to the natural language query; and
orchestrating collection of the identified data.

2. The computer-implemented method of claim 1, wherein processing the natural language query using the at least one model to identify the one or more sets of operations comprises matching one or more semantic tags determined from the natural language query to one or more semantic tags associated with the one or more sets of operations for data collection and analysis.

3. The computer-implemented method of claim 1, wherein identifying the one or more sets of operations for data collection and analysis from the plurality of sets of operations for data collection and analysis further comprises analyzing geocoding data.

4. The computer-implemented method of claim 1, wherein the one or more sets of operations for data collection and analysis, from among the plurality of sets of operations, comprise a second plurality of set of operations for data collection and analysis each selected for different aspects of the natural language query.

5. The computer-implemented method of claim 1, further comprising:
executing data collection steps and data analysis steps, of the one or more sets of operations for data collection and analysis, in an order defined by the one or more sets of operations for data collection and analysis.

6. The computer-implemented method of claim 1, wherein processing the natural language query to identify the one or more sets of operations comprises:
in response to determining, based on the processing, that a match has not been made based on the processing of the natural language query using the at least one model, presenting one or more candidate sets of operations for data collection and analysis to a user.

7. The computer-implemented method of claim 1, wherein processing the natural language query using the at least one model to identify the one or more sets of operations for data collection and analysis, from among the plurality of sets of operations for data collection and analysis, comprises identifying a facility type associated with a location, the location being associated with the natural language query.

8. The computer-implemented method of claim 1, further comprising:
generating a new set of operations for data collection and analysis based on the natural language query;
presenting the new set of operations for data collection and analysis to a reviewer for approval;
receiving approval of the new set of operations for data collection and analysis from the reviewer; and
adding the new set of operations for data collection and analysis to the plurality of sets of operations for data collection and analysis.

9. The computer-implemented method of claim 1, further comprising:
analyzing the collected data, the collected data comprising overhead imagery data;
generating, using at least one second model, a report based on the collected data and analysis of the collected data, the report generated using the at least one second model comprising natural language text; and
outputting the report.

10. The computer-implemented method of claim 9, wherein generating the report comprising the at least one second model comprises:
determining, based on a draft of the report, that supplemental data is to be collected for at least a portion of the analysis;
determining, based on the one or more sets of operations for data collection and analysis, supplemental data available for collection;
obtaining the supplemental data;
compiling the collected data and the supplemental data;
generating, using the at least one second model, a second draft of the report based on the compiled data and analysis of the compiled data.

11. The computer-implemented method of claim 1, wherein orchestrating collection of the identified data comprises:
identifying data to be collected for an analysis;
identifying candidate data sources for the data to be collected, available within one or more data sources;
selecting analysis data from the candidate data sources based on availability, cost, and compatibility with the analysis; and
obtaining the selected data from at least one of the one or more data sources.

12. The computer-implemented method of claim 11, further comprising,
analyzing the selected data;
generating, using at least one second model, a natural language report based on the selected data and analysis of the selected data; and
outputting the natural language report.

13. The computer-implemented method of claim 11, further comprising:
determining, based on one or more sets of operations for data collection and analysis, that there is an information gap between collected data and data to respond within a sufficiency threshold to the natural language query;
determining, based on the one or more sets of operations for data collection and analysis, supplemental data available to address the information gap;
obtaining the supplemental data;
compiling the collected data and the supplemental data;
analyzing the compiled data;
generating, using at least one second model, a report based on the compiled data and analysis of the compiled data, the report comprising natural language; and
outputting the report.

14. An apparatus comprising:
at least one processor; and
at least one computer-readable storage medium having encoded thereon executable instructions that, when executed by the at least one processor, cause the at least one processor to carry out a method comprising:
identifying data to be collected for an analysis;
identifying candidate data sources for the data to be collected, available within one or more data sources;
selecting analysis data from the candidate data sources based on availability, cost, and compatibility with the analysis; and
obtaining the selected data from at least one of the one or more data sources.

15. The apparatus of claim 14, wherein the method further comprises:
determining the one or more data sources based on one or more sets of operations for data collection and analysis that define data collection steps and data analysis steps.

16. The apparatus of claim 14, wherein selecting the analysis data comprises selecting based on a time of interest and a resolution of the candidate data.

17. The apparatus of claim 14, wherein the method further comprises:
identifying data to be collected for analysis, based at least in part on:
processing a natural language query using at least one model to identify one or more sets of operations for data collection and analysis from a plurality of sets of operations for data collection and analysis, each set of operations for data collection and analysis from the plurality of sets of operations for data collection and analysis associated with a domain; and
identifying, based on the one or more sets of operations for data collection and analysis, data comprising overhead imagery data to be collected for performing an analysis in response to the natural language query.

18. The apparatus of claim 14, wherein the one or more data sources comprise data sources accessed through multiple application programming interfaces.

19. The apparatus of claim 14, wherein selecting analysis data from the candidate data comprises selecting free data before archived data and selecting archived data before generated data.

20. At least one computer-readable storage medium having encoded thereon executable instructions that, when executed by at least one processor, cause the at least one processor to carry out a method, the method comprising:
determining, based on one or more sets of operations for data collection and analysis, that there is an information gap between collected data and data to respond within a sufficiency threshold to a user natural language query;
determining, based on the one or more sets of operations for data collection and analysis, supplemental data available to address the information gap;
obtaining the supplemental data; and
compiling the collected data and the supplemental data.

21. The at least one computer-readable storage medium of claim 20, wherein the method further comprises:
presenting an initial report from the collected data to a user;
presenting information regarding the information gap and suggested supplemental data to the user;
determining, based on input from the user, what supplemental data to obtain to address the information gap.

22. The at least one computer-readable storage medium of claim 20, wherein obtaining the supplemental data comprises:
interfacing with a plurality of data sources to identify candidate data satisfying data requirements to address the information gap;
selecting selected data from the candidate data based on availability, cost, and compatibility with the analysis; and
obtaining the selected data from at least one of the plurality of data sources.

23. The at least one computer-readable storage medium of claim 20, wherein obtaining the collected data comprises:
processing a natural language query using at least one model to identify one or more sets of operations for data collection and analysis from a plurality of sets of operations for data collection and analysis, each set associated with a domain;
identifying, based on the one or more sets of operations for data collection and analysis, data comprising overhead imagery data to be collected for performing an analysis in response to the natural language query;
identifying candidate data sources for the data to be collected available within one or more data sources;
selecting analysis data from the candidate data based on availability, cost, and compatibility with the analysis; and
obtaining the selected data from at least one of the one or more data sources.

24. The at least one computer-readable storage medium of claim 20, wherein the method further comprises deduplicating portions of the collected data and the supplemental data.

25. The at least one computer-readable storage medium of claim 20, wherein the method further comprises determining whether further supplemental data is needed after the supplemental data is obtained.
